(19) United States
(12) Patent Application Publication
(10) Pub. No.: US 2024/0153217 A1
(43) Pub. Date: May 9, 2024

(54) ELECTRONIC DEVICE FOR DISPLAYING MULTIMEDIA CONTENT AND METHOD THEREOF

(71) Applicant: Samsung Electronics Co., Ltd., Suwon-si (KR)

(72) Inventors: Miyeoung CHUNG, Suwon-si (KR); Hanbeen KIM, Suwon-si (KR); Gyounghwa NA, Suwon-si (KR); Soonsang PARK, Suwon-si (KR); Jaeyung YEO, Suwon-si (KR); Jongwon LEE, Suwon-si (KR)

(21) Appl. No.: 18/365,468

(22) Filed: Aug. 4, 2023

Related U.S. Application Data
(63) Continuation of application No. PCT/KR2023/009986, filed on Jul. 12, 2023.

(30) Foreign Application Priority Data
Nov. 9, 2022 (KR) 10-2022-0148951
Nov. 14, 2022 (KR) 10-2022-0152100

(51) Int. Cl. G06T 19/00; G02B 27/01; G06F 3/14

(52) U.S. Cl. CPC G06T 19/006; G02B 27/0172; G06F 3/14

(57) ABSTRACT

According to an embodiment, an electronic device receives information including first multimedia content and feedback data with respect to the first multimedia content from an external electronic device through a communication circuit. The electronic device displays at least one visual object associated with the feedback data in a first area of a display based on the received information. The electronic device displays second multimedia content obtained by changing at least a portion of the first multimedia content in a second area different from the first area, based on the feedback data identified by the information.

### CROSS-REFERENCE TO RELATED APPLICATIONS

This application is a continuation of International Application No. PCT/KR2023/009986 designating the United States, filed on Jul. 12, 2023, in the Korean Intellectual Property Receiving Office and claiming priority to Korean Patent Application Nos. 10-2022-0148951, filed on Nov. 9, 2022, in the Korean Intellectual Property Office and 10-2022-0152100, filed on Nov. 14, 2022, in the Korean Intellectual Property Office, the disclosures of each of which are incorporated by reference herein in their entireties.

### BACKGROUND

### Field

The disclosure relates to an electronic device for displaying multimedia content and a method thereof.

### Description of Related Art

In order to provide an enhanced user experience, an electronic device that provides an augmented reality (AR) service displaying information generated by computer in association with an external object in the real-world are being developed. The electronic device may be a wearable device that may be worn by a user. For example, the electronic device may be an AR glasses and/or a head-mounted device (HMD).

### SUMMARY

According to an embodiment, an electronic device may comprise: a communication circuit, a display, and a processor. The processor may be configured to receive, from an external electronic device via the communication circuit, information including first multimedia content and feedback data with respect to the first multimedia content. The processor may be configured to control the display to display, in a first area of the display, based on the received information, at least one visual object associated with the feedback data. The processor may be configured to, control the display to display, in a second area different from the first area, second multimedia content obtained by changing at least portion of the first multimedia content, based on the feedback data identified by the information.

According to an embodiment, a method of an electronic device may comprise receiving, from an external electronic device via a communication circuit, information including first multimedia content and feedback data with respect to the first multimedia content. The method of the electronic device may comprise displaying, in a first area of the display based on the received information, at least one visual object associated with the feedback data. The method of the electronic device may comprise displaying, in a second area different from the first area, second multimedia content obtained by changing at least portion of the first multimedia content, based on the feedback data identified by the information.

According to an embodiment, a non-transitory computer readable storage medium storing one or more programs, the one or more programs may comprise instructions which, when executed by a processor of an electronic device, cause the electronic device to receiving, from an external electronic device via a communication circuit, information including first multimedia content and feedback data with respect to the first multimedia content. The one or more programs may comprise instructions which, when executed by the processor of the electronic device, cause the electronic device to display, in a first area of the display based on the received information, at least one visual object associated with the feedback data. The one or more programs may comprise instructions which, when executed by the processor of the electronic device, cause the electronic device to display, in a second area different from the first area, second multimedia content obtained by changing at least portion of the first multimedia content based on the feedback data identified by the information.

According to an embodiment, an electronic device may comprise: a communication circuit, a display, and a processor. The processor may be configured to receive, from an external electronic device via the communication circuit, multimedia content and information for displaying a virtual space including the multimedia content. The processor may be configured to change, based on feedback data with respect to the multimedia content identified by the information, at least one of at least portion of the multimedia content or a location of the multimedia content in the virtual space. The processor may be configured to control the display to display, based on at least portion of the multimedia content or the changed location based on the feedback data, at least portion of the virtual space including the multimedia content in the display.

According to an embodiment, a method of an electronic device may comprise receiving, from an external electronic device via a communication circuit, multimedia content and information for displaying a virtual space including the multimedia content. The method of the electronic device may comprise changing, based on feedback data with respect to the multimedia content identified by the information, at least one of at least portion of the multimedia content or a location of the multimedia content in the virtual space. The method of the electronic device may comprise displaying, based on at least portion of the multimedia content or the changed location based on the feedback data, at least portion of the virtual space including the multimedia content in the display.

According to an embodiment, a non-transitory computer readable storage medium storing one or more programs, the one or more programs may comprise instructions which, when executed by a processor of an electronic device, cause electronic device to receive, from an external electronic device via the communication circuit, multimedia content and information for displaying a virtual space including the multimedia content. The one or more programs may comprise instructions which, when executed by the processor of the electronic device, cause the electronic device to change, based on feedback data with respect to the multimedia content identified by the information, at least one of at least portion of the multimedia content or a location of the multimedia content in the virtual space. The one or more programs may comprise instructions which, when executed by the processor of the electronic device, cause the electronic device to display, based on at least portion of the multimedia content or the changed location based on the feedback data, at least portion of the virtual space including the multimedia content in the display.

### BRIEF DESCRIPTION OF THE DRAWINGS

The above and other aspects, features and advantages of certain embodiments of the present disclosure will be more apparent from the following detailed description, take in conjunction with the accompanying drawings, in which:

FIG. 1 is a diagram illustrating an example environment in which a metaverse service is provided through a server;

FIG. 2 is a diagram illustrating an example environment in which a metaverse service is provided through a direct connection between user terminals and a second terminal;

FIG. 3A illustrates an example of a perspective view of a wearable device, according to an embodiment;

FIG. 3B illustrates an example of one various example components disposed in a wearable device, according to an embodiment;

FIGS. 4A and 4B are respectively front and rear perspective views illustrating an example appearance of a wearable device, according to an embodiment;

FIG. 5A illustrates an example of a block diagram of an electronic device, according to an embodiment;

FIG. 5B illustrates an example of a block diagram of an electronic device and an external electronic device, according to an embodiment;

FIG. 6 illustrates an example of a virtual space in which multimedia content is displayed, according to an embodiment;

FIG. 7A illustrates an example of a virtual space in which multimedia content is displayed, according to an embodiment;

FIG. 7B illustrates an example of a virtual space in which multimedia content is displayed, according to an embodiment;

FIG. 8A illustrates an example of a virtual space in which multimedia content is displayed, according to an embodiment;

FIG. 8B illustrates an example of a virtual space in which multimedia content is displayed, according to an embodiment;

FIG. 9A illustrates an example of a virtual space in which multimedia content is displayed, according to an embodiment;

FIG. 9B illustrates an example of a virtual space in which multimedia content is displayed, according to an embodiment;

FIG. 10 illustrates an example of a virtual space in which multimedia content is displayed, according to an embodiment;

FIG. 11 illustrates an example of a flowchart of an operation of an electronic device, according to an embodiment; and

FIG. 12 illustrates an example of a flowchart of an operation of an electronic device, according to an embodiment.

### DETAILED DESCRIPTION

Hereinafter, various embodiments of the present disclosure will be described in greater detail with reference to the accompanying drawings.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Metaverse is a combination of the English words Meta, which may refer to “virtual” and “transcendence,” and “Universe,” which may refer to the universe, and refers to a three-dimensional virtual world where social, economic, and cultural activities like the real world take place. Metaverse is a concept that has evolved further than virtual reality, and it is characterized using avatars to not only enjoy games or virtual reality (VR, cutting-edge technology that enables people to experience real-life experiences in a computerized virtual world), but also social and cultural activities like real reality.

Such a metaverse service may be provided in at least two forms. The first form is to provide services to users using a server, and the second form is to provide services through individual contacts between users.

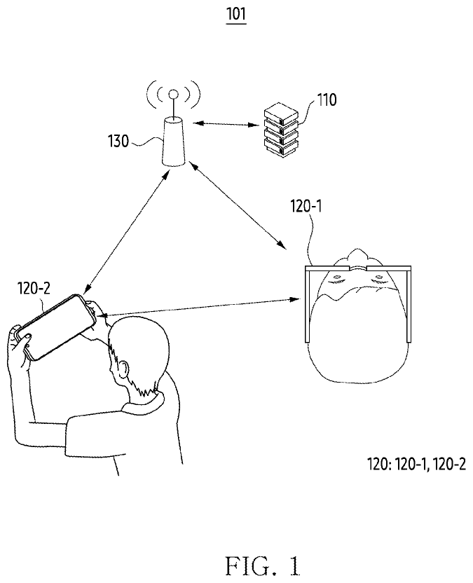

FIG. 1 is a diagram illustrating an example environment 101 in which a metaverse service is provided through a server 110.

Referring to FIG. 1, the environment 101 includes a server 110 providing a metaverse service, a network (e.g., a network formed by at least one intermediate node 130 including an access point (AP) and/or a base station) connecting the server 110 and each of the user terminal (e.g., a user terminal 120 including a first terminal 120-1 and a second terminal 120-2), a user terminal that enable the use of services by accessing the server through the network and providing input and output to the metaverse service to the user.

In this case, the server 110 provides a virtual space so that the user terminal 120 may perform an activity in the virtual space. In addition, the user terminal 120 installs an S/W agent for accessing the virtual space provided by the server 110 to represent the information provided by the server 110 to the user or transmits the information that the user wants to represent in the virtual space to the server.

The S/W agent may be directly provided through the server 110 or downloaded from a public server, or may be embedded when purchasing a terminal.

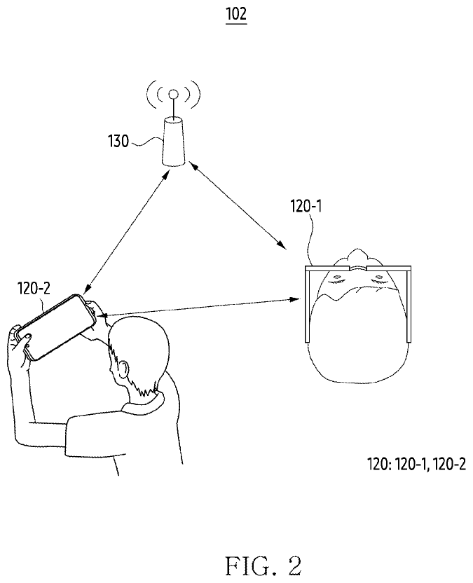

FIG. 2 is an example diagram of an example environment 102 in which a metaverse service is provided through direct connection between user terminals and a second terminal (e.g., a first terminal 120-1 and a second terminal 120-2).

Referring to FIG. 2, the environment 102 of the second embodiment includes a first terminal 120-1 providing a metaverse service, a network connecting each user terminal (e.g., a network formed by at least one intermediate node 130), and a second terminal 120-2 that allows a second user to use the service by inputting/outputting to the metaverse service by connecting to the first terminal 120-1 through the network.

The example embodiment is characterized in that the first terminal 120-1 provides a metaverse service by performing the role of a server (e.g., the server 110 of FIG. 1) in the first embodiment. That is, it may be seen that the metaverse environment may be configured only by connecting the device to the device.

In the various example embodiments, the user terminal 120 (or the user terminal 120 including the first terminal 120-1 and the second terminal 120-2) may be made of various form factors, and is characterized in that it includes an output device that provides an image or/and sound to a user and an input device for inputting information into a metaverse service. Examples of various form factors of the user terminal 120 may include a smartphone (e.g., the second terminal 120-2), an AR device (e.g., the first terminal 120-1), a VR device, an MR device, a VST device, or TV or projector capable of input/output, and the like.

The network of the present disclosure (e.g., a network formed by at least one intermediate node 130) may include, for example, all of various broadband networks including 3G, 4G, and 5G and a short-range network (e.g., a wired network or wireless network directly connecting the first terminal 120-1 and the second terminal 120-2) including Wi-Fi, BT, and the like.

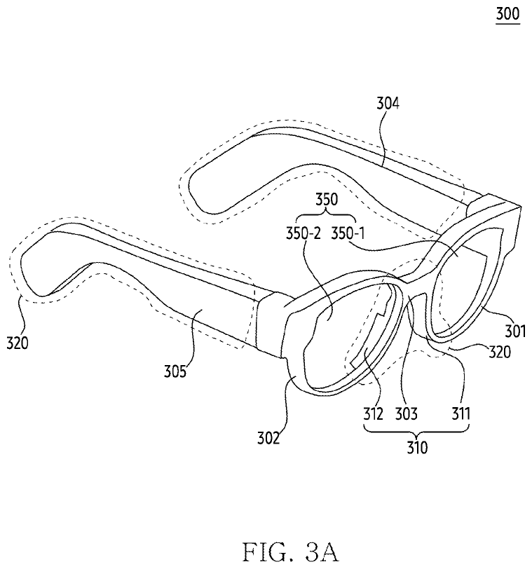

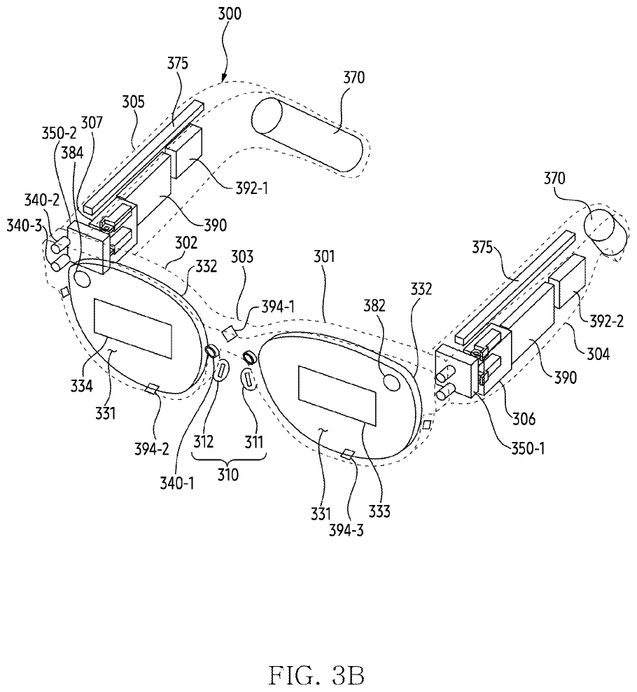

FIG. 3A illustrates an example of a perspective view of a wearable device 300 according to an embodiment. FIG. 3B is a perspective view illustrating various components of an example wearable device 300 according to an embodiment. The wearable device 300 of FIGS. 3A to 3B may include the first terminal 120-1 of FIGS. 1 to 2. As shown in FIG. 3A, according to an embodiment, the wearable device 300 may include at least one display 350 and a frame supporting the at least one display 350.

According to an embodiment, the wearable device 300 may be wearable on a portion of the user's body. The wearable device 300 may provide augmented reality (AR), virtual reality (VR), or mixed reality (MR) combining the augmented reality and the virtual reality to a user wearing the wearable device 300. For example, the wearable device 300 may output a virtual reality image to a user through the at least one display 350 in response to a user's preset gesture obtained through a motion recognition camera 340-2 of FIG. 3B.

According to an embodiment, the at least one display 350 in the wearable device 300 may provide visual information to a user. For example, the at least one display 350 may include a transparent or translucent lens. The at least one display 350 may include a first display 350-1 and/or a second display 350-2 spaced apart from the first display 350-1. For example, the first display 350-1 and the second display 350-2 may be disposed at positions corresponding to the user's left and right eyes, respectively.

Referring to FIG. 3B, the at least one display 350 may provide another visual information, which is distinct from the visual information, together with the visual information included in the ambient light passing through the lens, a user wearing the wearable device 300, by forming a display area on the lens. The lens may be formed based on at least one of a fresnel lens, a pancake lens, or a multi-channel lens. For example, the display area formed by the at least one display 350 may be formed on the second surface 332 among the first surface 331 and the second surface 332 of the lens. When the user wears the wearable device 300, the ambient light may be transmitted to the user by being incident on the first surface 331 and being penetrated through the second surface 332. For another example, the at least one display 350 may display the virtual reality image to be combined with a real screen transmitted through the ambient light. The virtual reality image output from the at least one display 350 may be transmitted to the user's eyes through the one or more hardware (e.g., optical devices 382 and 384, and/or at least one waveguides 333 and 334)) included in the wearable device 300.

According to an embodiment, the wearable device 300 may include the waveguides 333 and 334 that diffracts light transmitted from the at least one display 350 and relayed by the optical devices 382 and 384 and transmits it to the user. The waveguides 333 and 334 may be formed based on at least one of glass, plastic, or polymer. A nano pattern may be formed on at least a portion of the outside or inside of the waveguides 333 and 334. The nano pattern may be formed based on a grating structure having a polygonal or curved shape. Light incident to one end of the waveguides 333 and 334 may be propagated to the other end of the waveguides 333 and 334 by the nano pattern. The waveguides 333 and 334 may include at least one of at least one diffraction element (e.g., a diffractive optical element (DOE), a holographic optical element (HOE)), and a reflection element (e.g., a reflection mirror). For example, the waveguides 333 and 334 may be disposed in the wearable device 300 to guide a screen displayed by the at least one display 350 to the user's eyes. For example, the screen may be transmitted to the user's eyes based on total internal reflection (TIR) generated in the waveguides 333 and 334.

According to an embodiment, the wearable device 300 may analyze an object included in a real image collected through a photographing camera 340-1, combine virtual object corresponding to an object that become a subject of augmented reality provision among the analyzed object, and display them on the at least one display 350. The virtual object may include at least one of text and images for various information associated with the object included in the real image. The wearable device 300 may analyze the object based on a multi-camera such as a stereo camera. For the object analysis, the wearable device 300 may execute time-of-flight (ToF) and/or simultaneous localization and mapping (SLAM) supported by the multi-camera. The user wearing the wearable device 300 may watch an image displayed on the at least one display 350.

According to an embodiment, the frame may be configured with a physical structure in which the wearable device 300 may be worn on the user's body. According to an embodiment, the frame may be configured so that when the user wears the wearable device 300, the first display 350-1 and the second display 350-2 may be positioned corresponding to the user's left and right eyes. The frame may support the at least one display 350. For example, the frame may support the first display 350-1 and the second display 350-2 to be positioned at positions corresponding to the user's left and right eyes.

Referring to FIG. 3A, according to an embodiment, the frame may include an area 320 at least partially in contact with the portion of the user's body in case that the user wears the wearable device 300. For example, the area 320 in contact with the portion of the user's body of the frame may include an area contacting a portion of the user's nose, a portion of the user's ear, and a portion of the side of the user's face that the wearable device 300 contacts. According to an embodiment, the frame may include a nose pad 310 that is contacted on the portion of the user's body. When the wearable device 300 is worn by the user, the nose pad 310 may be contacted on the portion of the user's nose. The frame may include a first temple 304 and a second temple 305 that is contacted on another portion of the user's body that is distinct from the portion of the user's body.

For example, the frame may include a first rim 301 surrounding at least a portion of the first display 350-1, a second rim 302 surrounding at least a portion of the second display 350-2, a bridge 303 disposed between the first rim 301 and the second rim 302, a first pad 311 disposed along a portion of the edge of the first rim 301 from one end of the bridge 303, a second pad 312 disposed along a portion of the edge of the second rim 302 from the other end of the bridge 303, the first temple 304 extending from the first rim 301 and fixed to a portion of the wearer's ear, and the second temple 305 extending from the second rim 302 and fixed to a portion of the ear opposite to the ear. The first pad 311 and the second pad 312 may be in contact with the portion of the user's nose, and the first temple 304 and the second temple 305 may be in contact with a portion of the user's face and the portion of the user's ear. The temples 304 and 305 may be rotatably connected to the rim through hinge units 306 and 307 of FIG. 3B. The first temple 304 may be rotatably connected with respect to the first rim 301 through the first hinge unit 306 disposed between the first rim 301 and the first temple 304. The second temple 305 may be rotatably connected with respect to the second rim 302 through the second hinge unit 307 disposed between the second rim 302 and the second temple 305. According to an embodiment, the wearable device 300 may identify an external object (e.g., a user's fingertip) touching the frame and/or a gesture performed by the external object using a touch sensor, a grip sensor, and/or a proximity sensor formed on at least a portion of the surface of the frame.

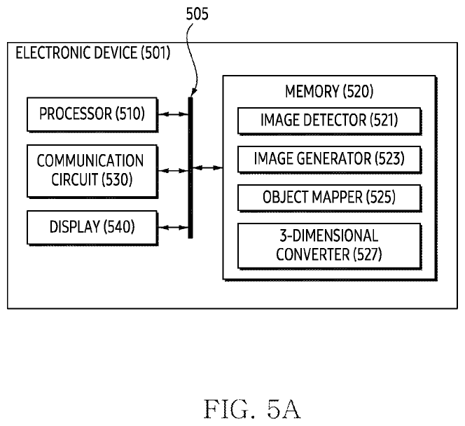

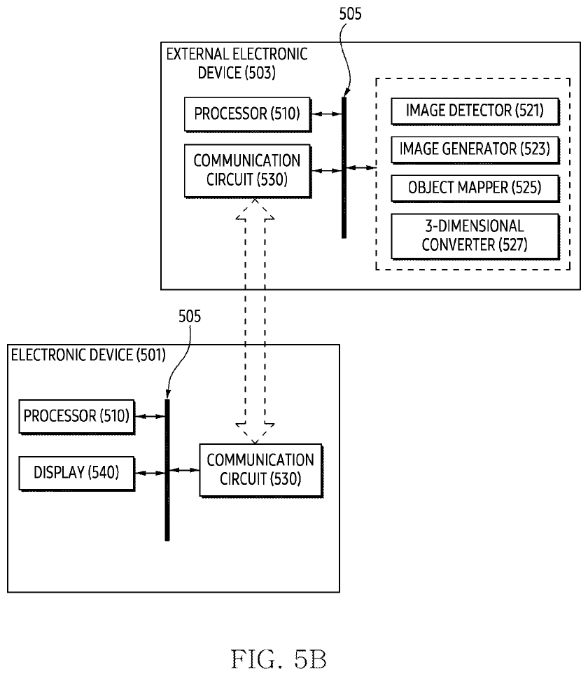

According to an embodiment, the wearable device 300 may include hardware (e.g., hardware described above based on the block diagram of FIG. 5A and/or FIG. 5B) that performs various functions. For example, the hardware may include a battery module 370, an antenna module 375, the optical devices 382 and 384, speakers 392-1 and 392-2, microphones 394-1, 394-2, and 394-3, a light emitting module (not illustrated), and/or a printed circuit board 390. Various hardware may be disposed in the frame.

According to an embodiment, the microphone 394-1, 394-2, and 394-3 of the wearable device 300 may obtain a sound signal, by being disposed on at least a portion of the frame. The first microphone 394-1 disposed on the nose pad 310, the second microphone 394-2 disposed on the second rim 302, and the third microphone 394-3 disposed on the first rim 301 are illustrated in FIG. 3B, but the number and disposition of the microphone 394 are not limited to an embodiment of FIG. 3B. In case that the number of the microphone 394 included in the wearable device 300 is two or more, the wearable device 300 may identify the direction of the sound signal using a plurality of microphones disposed on different portions of the frame.

According to an embodiment, the optical devices 382 and 384 may transmit the virtual object transmitted from the at least one display 350 to the waveguides 333 and 334. For example, the optical devices 382 and 384 may be a projector. The optical devices 382 and 384 may be disposed adjacent to the at least one display 350 or may be included in the at least one display 350 as portion of the at least one display 350. The first optical device 382 may correspond to the first display 350-1, and the second optical device 384 may correspond to the second display 350-2. The first optical device 382 may transmit the light output from the first display 350-1 to the first waveguide 333, and the second optical device 384 may transmit light output from the second display 350-2 to the second waveguide 334.

In an embodiment, a camera 340 may include an eye tracking camera (ET CAM) 340-1, the motion recognition camera 340-2, and/or the photographing camera 340-3. The photographing camera 340-3, the eye tracking camera 340-1, and the motion recognition camera 340-2 may be disposed at different positions on the frame and may perform different functions. The eye tracking camera 340-1 may output data indicating the gaze of the user wearing the wearable device 300. For example, the wearable device 300 may detect the gaze from an image including the user's pupil obtained through the eye tracking camera 340-1. An example in which the eye tracking camera 340-1 is disposed toward the user's right eye is illustrated in FIG. 3B, but the embodiment is not limited thereto, and the eye tracking camera 340-1 may be disposed alone toward the user's left eye or may be disposed toward two eyes.

In an embodiment, the photographing camera 340-3 may photograph a real image or background to be matched with a virtual image in order to implement the augmented reality or mixed reality content. The photographing camera may photograph an image of a specific object existing at a position viewed by the user and may provide the image to the at least one display 350. The at least one display 350 may display one image in which a virtual image provided through the optical devices 382 and 384 is overlapped with information on the real image or background including an image of the specific object obtained using the photographing camera. In an embodiment, the photographing camera may be disposed on the bridge 303 disposed between the first rim 301 and the second rim 302.

In an embodiment, the eye tracking camera 340-1 may implement a more realistic augmented reality by matching the user's gaze with the visual information provided on the at least one display 350 by tracking the gaze of the user wearing the wearable device 300. For example, when the user looks at the front, the wearable device 300 may naturally display environment information associated with the user's front on the at least one display 350 at the position where the user is positioned. The eye tracking camera 340-1 may be configured to capture an image of the user's pupil in order to determine the user's gaze. For example, the eye tracking camera 340-1 may receive gaze detection light reflected from the user's pupil and may track the user's gaze based on the position and movement of the received gaze detection light. In an embodiment, the eye tracking camera 340-1 may be disposed at a position corresponding to the user's left and right eyes. For example, the eye tracking camera 340-1 may be disposed in the first rim 301 and/or the second rim 302 to face the direction in which the user wearing the wearable device 300 is positioned.

In an embodiment, the motion recognition camera 340-2 may provide a specific event to the screen provided on the at least one display 350 by recognizing the movement of the whole or portion of the user's body, such as the user's torso, hand, or face. The motion recognition camera 340-2 may obtain a signal corresponding to the gesture by recognizing the user's gesture, and may provide a display corresponding to the signal to the at least one display 350. The processor may identify a signal corresponding to the operation and may perform a preset function based on the identification. In an embodiment, the motion recognition camera 340-2 may be disposed on the first rim 301 and/or the second rim 302.

In an embodiment, the camera 340 included in the wearable device 300 is not limited to the above-described eye tracking camera 340-1 and the motion recognition camera 340-2. For example, the wearable device 300 may identify an external object included in the FoV using the photographing camera 340-3 disposed toward the user's FoV. That the wearable device 300 identifies the external object may be performed based on a sensor for identifying a distance between the wearable device 300 and the external object, such as a depth sensor and/or a time of flight (ToF) sensor. The camera 340 disposed toward the FoV may support an autofocus function and/or an optical image stabilization (OIS) function. For example, the wearable device 300 may include the camera 340 (e.g., a face tracking (FT) camera) disposed toward the face in order to obtain an image including the face of the user wearing the wearable device 300.

Although not illustrated, the wearable device 300 according to an embodiment may further include a light source (e.g., LED) that emits light toward a subject (e.g., user's eyes, face, and/or an external object in the FoV) photographed using the camera 340. The light source may include an LED having an infrared wavelength. The light source may be disposed on at least one of the frame, and the hinge units 306 and 307.

According to an embodiment, the battery module 370 may supply power to electronic components of the wearable device 300. In an embodiment, the battery module 370 may be disposed in the first temple 304 and/or the second temple 305. For example, the battery module 370 may be a plurality of battery modules 370. The plurality of battery modules 370, respectively, may be disposed on each of the first temple 304 and the second temple 305. In an embodiment, the battery module 370 may be disposed at an end of the first temple 304 and/or the second temple 305.

In an embodiment, the antenna module 375 may transmit the signal or power to the outside of the wearable device 300 or may receive the signal or power from the outside. The antenna module 375 may be electronically and/or operably connected to the communication circuit of FIG. 2. In an embodiment, the antenna module 375 may be disposed in the first temple 304 and/or the second temple 305. For example, the antenna module 375 may be disposed close to one surface of the first temple 304 and/or the second temple 305.

In an embodiment, the speakers 392-1 and 392-2 may output a sound signal to the outside of the wearable device 300. A sound output module may be referred to as a speaker. In an embodiment, the speakers 392-1 and 392-2 may be disposed in the first temple 304 and/or the second temple 305 in order to be disposed adjacent to the ear of the user wearing the wearable device 300. For example, the wearable device 300 may include the second speaker 392-2 disposed adjacent to the user's left ear by being disposed in the first temple 304, and the first speaker 392-1 disposed adjacent to the user's right ear by being disposed in the second temple 305.

In an embodiment, the light emitting module (not illustrated) may include at least one light emitting element. The light emitting module may emit light of a color corresponding to a specific state or may emit light through an operation corresponding to the specific state in order to visually provide information on a specific state of the wearable device 300 to the user. For example, in case that the wearable device 300 needs charging, it may repeatedly emit red light at a preset timing. In an embodiment, the light emitting module may be disposed on the first rim 301 and/or the second rim 302.

Referring to FIG. 3B, according to an embodiment, the wearable device 300 may include the printed circuit board (PCB) 390. The PCB 390 may be included in at least one of the first temple 304 or the second temple 305. The PCB 390 may include an interposer disposed between at least two sub PCBs. On the PCB 390, one or more hardware included in the wearable device 300 may be disposed. The wearable device 300 may include a flexible PCB (FPCB) for interconnecting the hardware.

According to an embodiment, the wearable device 300 may include at least one of a gyro sensor, a gravity sensor, and/or an acceleration sensor for detecting the posture of the wearable device 300 and/or the posture of a body part (e.g., a head) of the user wearing the wearable device 300. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 300 may identify the user's motion and/or gesture performed to execute or stop a specific function of the wearable device 300 based on the IMU.

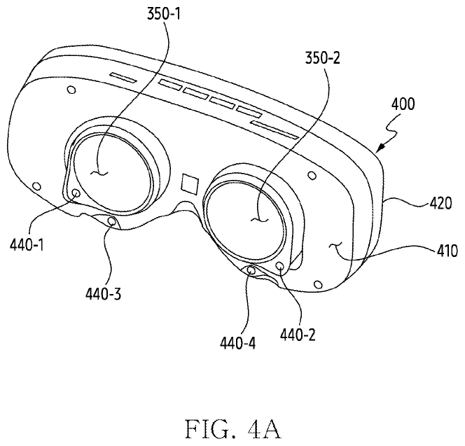

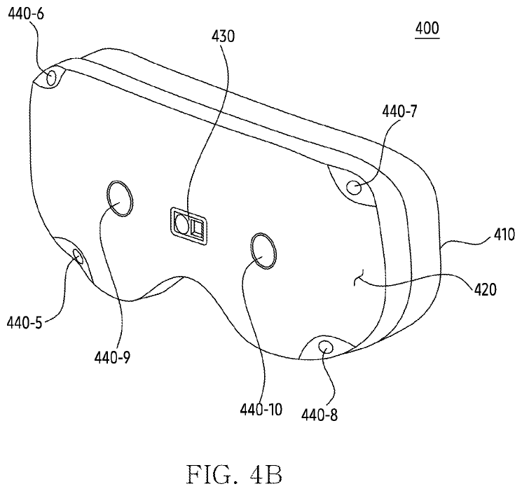

FIGS. 4A and 4B illustrate an example appearance of a wearable device 400 according to an embodiment. The wearable device 400 of FIGS. 4A and 4B may include a first terminal 120-1 of FIGS. 1 to 2. According to an embodiment, an example of an appearance of a first surface 410 of the housing of the wearable device 400 may be illustrated in FIG. 4A, and an example of an appearance of a second surface 420 opposite to the first surface 410 may be illustrated in FIG. 4B.

Referring to FIG. 4A, according to an embodiment, the first surface 410 of the wearable device 400 may have an attachable shape on the user's body part (e.g., the user's face). Although not illustrated, the wearable device 400 may further include a strap for being fixed on the user's body part, and/or one or more temples (e.g., a first temple 304 and/or a second temple 305 of FIGS. 3A to 3B). A first display 350-1 for outputting an image to the left eye among the user's two eyes and a second display 350-2 for outputting an image to the right eye among the user's two eyes may be disposed on the first surface 410. The wearable device 400 may be formed on the first surface 410 and may further include rubber or silicon packing for preventing and/or reducing interference by light (e.g., ambient light) different from the light emitted from the first display 350-1 and the second display 350-2.

According to an embodiment, the wearable device 400 may include cameras 440-1 and 440-2 for photographing and/or tracking two eyes of the user adjacent to each of the first display 350-1 and the second display 350-2. The cameras 440-1 and 440-2 may be referred to as ET cameras. According to an embodiment, the wearable device 400 may include cameras 440-3 and 440-4 for photographing and/or recognizing the user's face. The cameras 440-3 and 440-4 may be referred to as FT cameras.

Referring to FIG. 4B, according to an embodiment, a camera (e.g., cameras 440-5, 440-6, 440-7, 440-8, 440-9, and 440-10), and/or a sensor (e.g., a depth sensor 430) for obtaining information associated with the external environment of the wearable device 400 may be disposed on the second surface 420 opposite to the first surface 410 of FIG. 4A. For example, the cameras 440-5, 440-6, 440-7, 440-8, 440-9, and 440-10 may be disposed on the second surface 420 in order to recognize an external object different from the wearable device 400. For example, using cameras 440-9, and 440-10, the wearable device 400 may obtain an image and/or video to be transmitted to each of the user's two eyes. The camera 440-9 may be disposed on the second surface 420 of the wearable device 400 to obtain an image to be displayed through the second display 350-2 corresponding to the right eye among the two eyes. The camera 440-10 may be disposed on the second surface 420 of the wearable device 400 to obtain an image to be displayed through the first display 350-1 corresponding to the left eye among the two eyes.

According to an embodiment, the wearable device 400 may include the depth sensor 430 disposed on the second surface 420 in order to identify a distance between the wearable device 400 and the external object. Using the depth sensor 430, the wearable device 400 may obtain spatial information (e.g., a depth map) about at least a portion of the FoV of the user wearing the wearable device 400.

Although not illustrated, a microphone for obtaining sound output from the external object may be disposed on the second surface 420 of the wearable device 400. The number of microphones may be one or more depending on embodiments.

As described above, according to an embodiment, the wearable device 400 may have a form factor for being worn on a user's head. The wearable device 400 may provide a user experience based on augmented reality, virtual reality, and/or mixed reality in a state of being worn on the head. In conjunction with an object included in at least one display 350 in the wearable device 400, the wearable device 400 may output multimedia content. The multimedia content output in conjunction with the object may be selected based on a relationship between users browsing the object through one or more external electronic devices different from the wearable device 400 and the user wearing the wearable device 400. The multimedia content may be selected by a server (e.g., a server 110 of FIG. 1) for providing a metaverse service based on the object.

Hereinafter, an example of an operation in which a wearable device (e.g., the first terminal 120-1 of FIGS. 1 to 2) including the wearable device 300 of FIGS. 3A and 3B and/or the wearable device 400 of FIGS. 4A and 4B displays multimedia content will be described in greater detail with reference to FIGS. 5A and/or 5B.

FIG. 5A illustrates an example of a block diagram of an electronic device, according to an embodiment. FIG. 5B illustrates an example of a block diagram of an electronic device and an external electronic device, according to an embodiment. The electronic devices 501 of FIGS. 5A and 5B may include the first terminal 120-1 of FIGS. 1 and 2. The electronic device 501 of FIGS. 5A and 5B may include the wearable device 300 of FIGS. 3A and 3B and/or the wearable device 400 of FIGS. 4A and 4B. An external electronic device 503 of FIG. 5B may include the server 110 of FIG. 1.

Referring to FIG. 5A, according to an embodiment, the electronic device 501 may include at least one of a processor (e.g., including processing circuitry) 510, a memory 520, a communication circuit 530, and/or a display 540. The processor 510, the memory 520, the communication circuit 530, and the display 540 are electronically and/or operably coupled with each other by an electronical component such as a communication bus 505. Hereinafter, the operational coupling of hardware may refer, for example, to a direct or indirect connection between hardware being established by wire or wirelessly, so that a second hardware is controlled by a first hardware among the hardware. Although illustrated based on different blocks, embodiments are not limited thereto, and a portion of the hardware of FIGS. 5A and/or 5B (e.g., at least a portion of the processor 510, the memory 520, and the communication circuit 520) may be included in a single integrated circuit such as a system on a chip (SoC). The type and/or number of hardware included in the electronic device 501 is not limited to an embodiment of FIGS. 5A and/or 5B. For example, the electronic device 501 may include only a portion of the hardware illustrated in FIGS. 5A and/or 5B.

Referring to FIG. 5B, according to an embodiment, the electronic device 501 may include at least one of a processor (e.g., including processing circuitry) 510, a communication circuit 530, or a display 540. According to an embodiment, the external electronic device 503 may include at least one of the processor (e.g., including processing circuitry) 510, the communication circuit 530, an image detector (e.g., including various processing circuitry and/or executable program instructions) 521, an image generator (e.g., including various processing circuitry and/or executable program instructions) 523, an object mapper (e.g., including various processing circuitry and/or executable program instructions) 525, and/or a 3-dimensional converter (e.g., including various processing circuitry and/or executable program instructions) 527. The external electronic device 503 may be referred to as a server.

Referring to FIGS. 5A and 5B, according to an embodiment, the processor 510 of the electronic device 501 may include hardware for processing data based on one or more instructions. The hardware for processing data may include, for example, an arithmetical and logical unit (ALU), a floating point unit (FPU), a field programmable gate array (FPGA), a central processing unit (CPU), and/or an application processor (AP). The processor 510 may have a structure of a single-core processor, or a structure of a multi-core processor such as a dual core, a quad core, a hexa, or an octa core.

According to an embodiment, the memory 520 of the electronic device 501 may include a hardware component for storing data and/or instructions input and/or output to the processor 510 of the electronic device 501. The memory 520 may include a volatile memory such as a random-access memory (RAM) and/or a non-volatile memory such as a read-only memory (ROM). For example, the volatile memory may include at least one of a dynamic RAM (DRAM), a static RAM (SRAM), a Cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SSD), and an embedded multimedia card (eMMC).

According to an embodiment, the memory 520 of the electronic device 501 may include at least one of the image detector 521, the image generator 523, the object mapper 525, or a 3-dimensional converter 527, each of which may include executable program instructions. The electronic device 501 may execute at least one of the image detector 521, the image generator 523, the object mapper 525, and the 3-dimensional converter 527 included in the memory 520. Based on the execution, the electronic device 501 may perform an operation for changing and/or displaying multimedia content. According to an embodiment, the external electronic device 503 may include at least one of the image detector 521, the image generator 523, the object mapper 525, and the 3-dimensional converter 527.

According to an embodiment, the communication circuit 530 of the electronic device 501 may include a hardware component to support transmission and/or reception of an electrical signal between the electronic device 501 and the server. Although only the external electronic device 503 is illustrated as an electronic device connected to the wearable device 501 through the communication circuit 530, the embodiment is not limited thereto. The communication circuit 530 may include, for example, at least one of a MODEM, an antenna, and an optic/electronic (O/E) converter. The communication circuit 530 may support transmission and/or reception of an electrical signal, based on various types of protocols, such as Ethernet, a local area network (LAN), a wide area network (WAN), a wireless fidelity (Wi-Fi), Bluetooth, Bluetooth low energy (BLE), ZigBee, a long term evolution (LTE), 5G new radio (NR). According to an embodiment, the electronic device 501 and the external electronic device 503 may be connected by wire or wirelessly through the communication circuit 530.

According to an embodiment, the display 540 of the electronic device 501 may output visualized information to a user. For example, the display 540 may be controlled by the processor 510 including a circuit such as a graphic processing unit (GPU) to output visualized information to the user. The display 540 may include a flat panel display (FPD) and/or an electronic paper. The FPD may include a liquid crystal display (LCD), a plasma display panel (PDP), and/or one or more light emitting diode (LED). The LED may include an organic LED (OLED). The display 540 of FIGS. 5A and/or 5B may include at least one display 350 of FIGS. 3A to 3B and/or 4A to 4B.

According to an embodiment, the electronic device 501 may receive information from the external electronic device 503 through the communication circuit 530. For example, the electronic device 501 may receive information including first multimedia content and feedback data with respect to the first multimedia content from the external electronic device 503 through the communication circuit 530. For example, the first multimedia content may include visually represented content such as an image and/or a video. For example, the feedback data may include a comment, positive and/or negative reactions with respect to the first multimedia content.

According to an embodiment, the electronic device 501 may identify a visual object such as a subject included in the first multimedia content using the image detector 521. The electronic device 501 may identify a location of the visual object in the first multimedia content, based on the identification of the visual object. For example, the electronic device 501 may identify the location of the visual object included in the image. The electronic device 501 may identify the type and/or category of the identified visual object, based on the identification of the visual object. For example, the type and/or category of the visual object may include characteristic of the visual object, classification of the visual object, material of the visual object, or name of the visual object. According to an embodiment, the electronic device 501 may identify a second visual object different from the visual object, which is a first visual object, in the first multimedia content. The electronic device 501 may identify a relative location between the first visual object and the second visual object, based on the identification of the second visual object in the first multimedia content. However, it is not limited thereto.

According to an embodiment, the electronic device 501 may display at least one visual object associated with the feedback data in a first area of the display 540, based on receiving information including the feedback data with respect to the first multimedia content. The visual object may include a third visual object different from the first visual object and the second visual object. For example, the first area may include an area for displaying at least one third visual object associated with the feedback data. A location of the first area is not limited. For example, the feedback data may be transmitted through a first external electronic device from a second external electronic device different from the external electronic device, which is the first external electronic device. For example, the feedback data may be transmitted by a user of the second external electronic device. The electronic device 501 may change the first multimedia content to the second multimedia content, based on receiving the feedback data. For example, the electronic device 501 may obtain the second multimedia content by changing at least a portion of the first multimedia content. For example, the second multimedia content may be obtained based on changing size of the at least a portion of the first multimedia content. For example, the second multimedia content may be obtained based on changing color of the at least a portion of the first multimedia content. For example, the second multimedia content may be obtained based on displaying a visual object (e.g., a figure such as a circle or a polygon) surrounding at least a portion of the first multimedia content.

According to an embodiment, the electronic device 501 may display a visual object included in the first multimedia content in a virtual space, based on the image generator 523. The electronic device 501 may change the first visual object identified based on the image detector 521. For example, the electronic device 501 may change the first visual object based on an image associated with the first visual object stored in the memory 520. For example, the electronic device 501 may identify an image matched with the first visual object in the memory 520. The electronic device 501 may change the first visual object to the image matched with the first visual object, based on identifying the matched image. The electronic device 501 may change the second visual object based on substantially the same operation as changing the first visual object to a matched image. The electronic device 501 may obtain the second multimedia content, based on the change of the first visual object and/or the second visual object.

According to an embodiment, the electronic device 501 may identify whether to change a visual object included in the first multimedia content based on the object mapper 525. For example, the electronic device 501 may identify whether a visual object included in the first multimedia content matches with text received from the memory 520 of the electronic device 501 and/or an external electronic device (e.g., a server). For example, the text may be feedback data with respect to the first multimedia content. For example, the electronic device 501 may encode a visual object included in the first multimedia content. The electronic device 501 may obtain first data associated with the visual object obtained based on the encoding. The electronic device 501 may encode the text. The electronic device 501 may obtain second data associated with the text based on the encoding of the text. The electronic device 501 may identify whether the first data and the second data match. For example, the electronic device 501 may identify whether the first data and the second data match, based on information obtained based on a hardware (e.g., neural processing unit (NPU), and/or graphic processing unit (GPU)) for performing calculation associated with artificial intelligence, a software for providing a function associated with the artificial intelligence, and/or an external electronic device (e.g., a server providing a function associated with the artificial intelligence).

According to an embodiment, the electronic device 501 may identify whether to change the visual object based on identifying the matching of the first data and the second data. The electronic device 501 may identify a location to display the visual object in 3-dimensional virtual coordinate system based on identifying whether to change the visual object. For example, the 3-dimensional virtual coordinate system may include an x-axis, a y-axis, and a z-axis. The axes may be formed at 90 degrees to each other. However, it is not limited thereto. For example, the electronic device 501 may display the visual object based on a 2-dimensional virtual coordinate system. For example, the 2-dimensional virtual coordinate system may include the x-axis and the y-axis. The axes may be formed at 90 degrees to each other. However, it is not limited thereto.

According to an embodiment, the electronic device 501 may display the first visual object based on the 3-dimensional converter 527. The electronic device 501 may obtain a 3-dimensional virtual object for changing the first visual object from the memory 520 and/or an external electronic device. For example, the electronic device 501 may obtain the 3-dimensional virtual object in common 3D model database (DB). For example, the electronic device 501 may change the first visual object included in the first multimedia content into the obtained 3-dimensional virtual object. The first visual object may include a virtual object such as a desk, a frame, a chair, or a calendar. The first visual object may include a virtual object such as a wall, floor, or ceiling for configuring a virtual space. The electronic device 501 may change the first visual object to the 3-dimensional virtual object based on identifying the 3-dimensional virtual object for changing the first visual object. However, it is not limited thereto. For example, the first visual object may be at least a portion of the first multimedia content. The electronic device 501 may obtain the second multimedia content based on the change of the first visual object, which is at least a portion of the first multimedia content. The electronic device 501 may display the second multimedia content in the display 540, based on obtaining of the second multimedia content.

According to an embodiment, when a 3-dimensional virtual object matching the first visual object does not exist in the common 3D model DB, the electronic device 501 may render the first visual object. The electronic device 501 may obtain the second multimedia content based on the rendered first visual object. The electronic device 501 may display the second multimedia content including the rendered first visual object.

According to an embodiment, the above-described operations of the electronic device 501 may be performed substantially the same by the external electronic device 503. For example, the external electronic device 503 may perform substantially the same operations as the above-described operations based on the image detector 521, the image generator 523, the object mapper 525, and/or the 3-dimensional converter 527 included in the external electronic device 503.

As described above, according to an embodiment, the electronic device 501 may receive information including the first multimedia content and feedback data with respect to the first multimedia content. The electronic device 501 may display at least one visual object associated with the feedback data in a first area of the display 540 based on the received information. The electronic device 501 may change at least a portion of the first multimedia content based on the feedback data identified by the information. The electronic device 501 may obtain the second multimedia content based on the change of at least a portion of the first multimedia content. The electronic device 501 may display the second multimedia content based on obtaining of the second multimedia content in a second area different from the first area. The electronic device 501 may display the second multimedia content obtained by changing at least a portion of the first multimedia content. The electronic device 501 may obtain the second multimedia content based on the first multimedia content and the feedback data. The electronic device 501 may obtain the second multimedia content based on changing at least a portion of the first multimedia content using the feedback data. The electronic device 501 may display the second multimedia content to be matched with the user's purpose based on the feedback data. The electronic device 501 may enhance a user experience of the electronic device 501 by displaying the second multimedia content based on the feedback data.

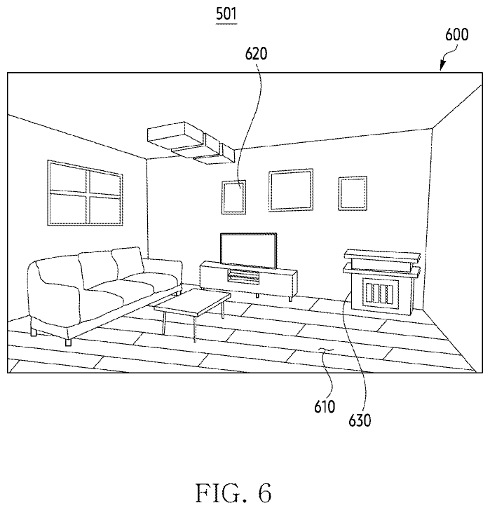

FIG. 6 illustrates an example of a virtual space in which multimedia content is displayed, according to an embodiment. An electronic device 501 of FIG. 6 may include the electronic device 501 of FIG. 5A and/or FIG. 5B. Operations of FIG. 6 may be executed by the processor 510 of FIG. 5A and/or FIG. 5B.

Referring to FIG. 6, according to an embodiment, the electronic device 501 may receive information including first multimedia content from an external electronic device through a communication circuit (e.g., the communication circuit 530 of FIG. 5A and/or FIG. 5B). The electronic device 501 may display a virtual space 600 including the first multimedia content in a display (e.g., the display 540 of FIG. 5A and/or FIG. 5B), based on receiving the information. For example, the virtual space 600 may be configured as a 3-dimensional virtual coordinate system. In order to implement the virtual space 600, the first multimedia content may include a first virtual object 610 such as a floor, a second virtual object 620 such as a picture frame, and/or a third virtual object 630 such as a fireplace. The virtual objects 610, 620, and 630 may be at least a portion of the first multimedia content. The virtual objects 610, 620, and 630 are not limited to those described above.

According to an embodiment, the electronic device 501 may receive information including the first multimedia content. The electronic device 501 may identify information associated with a real space matching the virtual space 600, in the information including the first multimedia content. The information associated with the real space may include information associated with name of the real space and/or a location of the real space. However, it is not limited thereto. The electronic device 501 may obtain information associated with the virtual space 600 matching the information associated with the real space. For example, the electronic device 501 may obtain information associated with the virtual space 600 matching information associated with the real space from an external electronic device through a communication circuit. The electronic device 501 may display the virtual space 600 based on information associated with the virtual space 600 transmitted from the external electronic device. For example, the electronic device 501 may display the virtual space 600, based on a real space based on the 3-dimensional virtual coordinate system.

According to an embodiment, the electronic device 501 may identify a characteristic of the first virtual object 610. For example, the characteristics may be associated with at least one of material of the first virtual object 610, color of the virtual object 610, or shape of the first virtual object 610. However, it is not limited thereto. The electronic device 501 may change the first virtual object 610 for representing the characteristic based on identifying the characteristic of the first virtual object 610. The electronic device 501 may change the first virtual object 610 based on the characteristic of the first virtual object 610. For example, the electronic device 501 may display the first virtual object 610 reflecting the characteristic in the virtual space 600. For example, the electronic device 501 may receive a signal associated with the characteristic of the first virtual object 610, from an external electronic device, in order to reflect the characteristic of the first virtual object 610. The electronic device 501 may change the first virtual object 610, based on receiving a signal associated with the characteristic of the first virtual object 610. The electronic device 501 may obtain second multimedia content based on changing the first virtual object 610.

According to an embodiment, the electronic device 501 may identify a characteristic of the second virtual object 620. For example, the characteristic may include at least one of the material of the second virtual object 620, color of the virtual object 620, shape of the second virtual object 620, or name of the second virtual object 620. However, it is not limited thereto. The electronic device 501 may change the second virtual object 620, based on identifying the characteristic of the second virtual object 620. For example, the electronic device 501 may transmit a signal for requesting the transmission of information associated with the characteristic of the second virtual object 620 to an external electronic device. The electronic device 501 may receive information associated with the characteristic of the second virtual object 620 from the external electronic device receiving the signal. The electronic device 501 may change the second virtual object 620 based on receiving information associated with the characteristic of the second virtual object 620. The electronic device 501 may obtain the second multimedia content based on changing the second virtual object 620.

According to an embodiment, the electronic device 501 may identify a characteristic of the third virtual object 630. For example, the characteristic may include at least one of material of the third virtual object 630, size of the third virtual object 630, name of the third virtual object 630, color of the third virtual object 630, or shape of the third virtual object 630. However, it is not limited thereto. The electronic device 501 may receive information including the characteristic of the third virtual object 630 from an external electronic device. The electronic device 501 may change the third virtual object 630 based on receiving the information including the characteristic of the third virtual object 630. The electronic device 501 may obtain the second multimedia content based on changing the third virtual object 630.

According to an embodiment, the electronic device 501 may identify information matching information associated with characteristics of the first virtual object 610, the second virtual object 620, and/or the third virtual object 630 within a memory (e.g., the memory 520 of FIG. 5A). The electronic device 501 may change the virtual objects 610, 620, and 630 based on identification of information matching the virtual objects 610, 620, and 630. The electronic device 501 may obtain the second multimedia content based on changing the virtual objects 610, 620, and 630. However, it is not limited thereto.

As described above, according to an embodiment, the electronic device 501 may receive information including the first multimedia content from an external electronic device through a communication circuit. The electronic device 501 may identify virtual objects 610, 620, and 630 included in the first multimedia content. The electronic device 501 may change the virtual objects 610, 620, and 630 that are at least a portion of the first multimedia content. The electronic device 501 may change the virtual objects 610, 620, and 630, based on information associated with characteristics of the virtual objects 610, 620, and 630. The electronic device 501 may obtain the second multimedia content based on changing the virtual objects 610, 620, and 630. The electronic device 501 may display the second multimedia content based on obtaining the second multimedia content. The electronic device 501 may enhance a user experience of the electronic device 501 by displaying the second multimedia content in which at least a portion of the first multimedia content is changed.

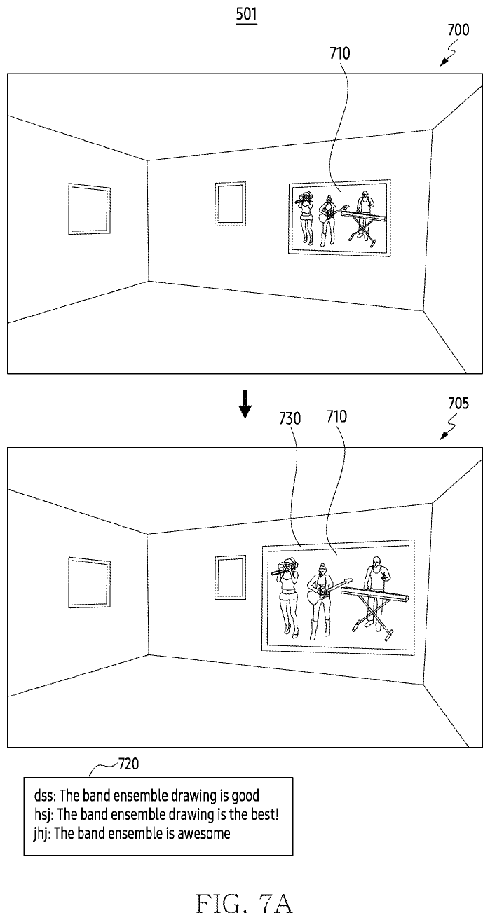

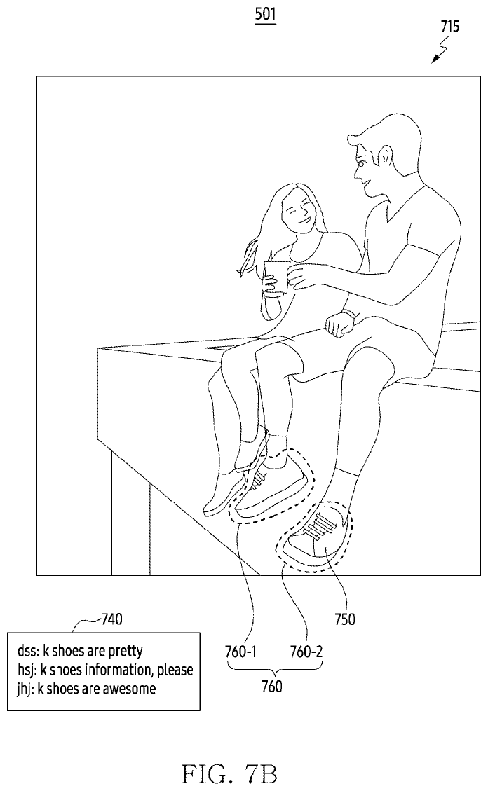

FIG. 7A illustrates an example of a virtual space in which multimedia content is displayed, according to an embodiment. FIG. 7B illustrates an example of a virtual space in which multimedia content is displayed, according to an embodiment. An electronic device 501 of FIGS. 7A and 7B may include the electronic device 501 of FIGS. 5A, 5B, and/or 6. Operations of FIGS. 7A and 7B may be executed by the processor 510 of FIGS. 5A and/or 5B. According to an embodiment, FIGS. 7A and 7B are an example in which the electronic device 501 includes a positive response in feedback data received from an external electronic device.

Referring to FIGS. 7A and 7B, according to an embodiment, the electronic device 501 may receive information including the first multimedia content and feedback data with respect to the first multimedia content from an external electronic device through a communication circuit (e.g., the communication circuit 530 of FIG. 5A and/or FIG. 5B).

Referring to FIG. 7A, the electronic device 501 may receive information including the first multimedia content 700. The electronic device 501 may receive information including feedback data 720 with respect to the first multimedia content 700. For example, the electronic device 501 may display the first multimedia content 700 in a display (e.g., the display 540 of FIG. 5A and/or FIG. 5B). For example, the electronic device 501 may display the first multimedia content 700 based on a 3-dimensional virtual coordinate system. For example, the electronic device 501 may display the feedback data 720 with respect to the first multimedia content 700 in the display. The electronic device 501 may change a portion of the first multimedia content 700 using the feedback data 720 with respect to the first multimedia content. For example, a portion of the first multimedia content 700 may include a visual object 710 included in the first multimedia content 700.

According to an embodiment, the electronic device 501 may change the visual object 710 that is a portion of the first multimedia content 700, based on the feedback data 720 with respect to the first multimedia content 700. For example, the feedback data 720 may include a reaction with respect to the visual object 710. For example, the feedback data 720 may include a positive reaction with respect to the visual object 710. In an example of FIG. 7A, the electronic device 501 may identify a positive reaction with respect to the visual object 710 included in the feedback data 720. For example, the positive reaction may include text such as ‘good’, ‘awesome’, ‘beautiful’, and/or ‘great’. However, it is not limited thereto. For example, the electronic device 501 may identify whether at least a portion of name of the visual object 710 and the feedback data 720 match. The electronic device 501 may identify name of the visual object 710, based on identifier included in the visual object 710.

In an example of FIG. 7A, the electronic device 501 may identify a ‘band ensemble’, which is name of the visual object 710, based on identifier included in the visual object 710. The electronic device 501 may identify at least one text included in the feedback data 720, based on the identification of the ‘band ensemble’, which is name of the visual object 710. The electronic device 501 may identify text ‘band ensemble’, which is included in the feedback data 720 and matches name of the visual object 710. The electronic device 501 may change the visual object 710, based on the identification of the ‘band ensemble’, which is text matching the name of the visual object 710 included in the feedback data 720. For example, when a positive reaction is included in the feedback data 720, the electronic device 501 may highlight the visual object 710. For example, highlighting the visual object 710 may include an operation of adjusting a location where the visual object 710 is displayed in the 3-dimensional virtual coordinate system. For example, highlighting the visual object 710 may include expanding size of the visual object 710. The electronic device 501 may obtain the visual object 730 by changing the visual object 710. The electronic device 501 may obtain the second multimedia content 705 based on obtaining the changed visual object 730. The electronic device 501 may display the second multimedia content 705 in the display, based on obtaining the second multimedia content 705. According to an embodiment, the electronic device 501 may display a visual object, which is adjacent to the visual object 710 or the changed visual object 730 and displaying the feedback data 720 as text.

Referring to FIG. 7B, according to an embodiment, the electronic device 501 may receive information including the first multimedia content 715 from an external electronic device through a communication circuit. The electronic device 501 may receive the feedback data 740 associated with the first multimedia content 715 from the external electronic device through the communication circuit. For example, the feedback data 740 may be generated based on a signal transmitted from a second external electronic device different from the external electronic device, which is a first external electronic device. For example, the feedback data 740 may be configured as text, such as a comment on the first multimedia content 715. For example, the feedback data 740 may include a figure and/or a polygon such as a ‘heart shape’. However, it is not limited thereto.

According to an embodiment, the electronic device 501 may identify a visual object 750 corresponding to a portion included in the first multimedia content 715, based on the feedback data 740. For example, the electronic device 501 may identify the visual object 750 corresponding to ‘k shoes’ based on the text ‘k shoes’ included in the feedback data 740. The electronic device 501 may obtain an image matching the ‘k shoes’ from an external electronic device based on identifying the text ‘k shoes’. For example, the electronic device 501 may transmit a signal to request an image matching the ‘k shoe’ to the external electronic device. For example, the electronic device 501 may receive an image matching the ‘k shoes’ from an external electronic device receiving the signal. The electronic device 501 may identify ‘k shoes’, which is a visual object corresponding to the image, based on receiving the image.

According to an embodiment, the electronic device 501 may classify the feedback data 740 based on identifying the visual object 750 corresponding to the ‘k shoes’ included in the feedback data 740. For example, the electronic device 501 may identify that the feedback data 740 includes a positive reaction, or that the feedback data 740 includes a negative reaction. The electronic device 501 may change the visual object 750 based on classifying the feedback data 740 into positive or negative reactions. In an example of FIG. 7B, the electronic device 501 may identify the feedback data 740 including the positive reaction. The electronic device 501 may highlight the visual object 750, based on identifying of the feedback data 740 including the positive reaction. For example, the electronic device 501 may display a second visual object 760 different from the first visual object 750 to highlight the visual object 750. When the first visual object 750 forms a pair, the electronic device 501 may display a plurality of second visual objects 760-1 and 760-2 to highlight the first visual object 750.

As described above, according to an embodiment, the electronic device 501 may highlight the visual object 750 based on the feedback data 740 with respect to the visual object 750. The electronic device 501 may enhance a user experience of the electronic device 501 by highlighting the visual object 750.

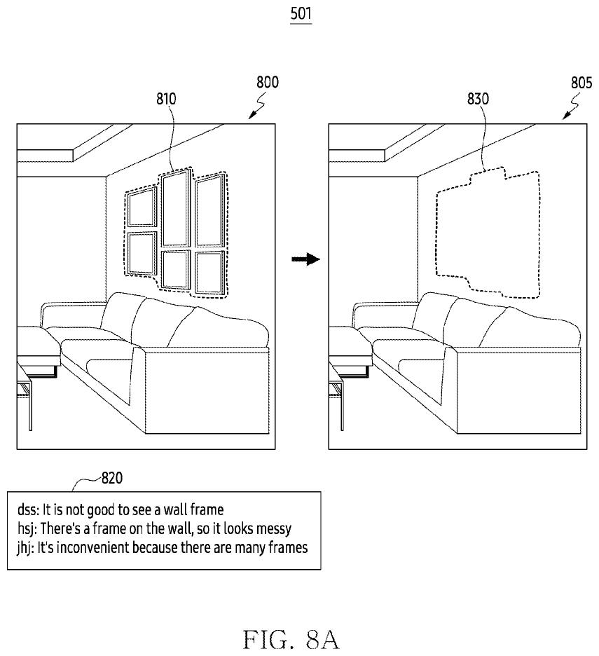

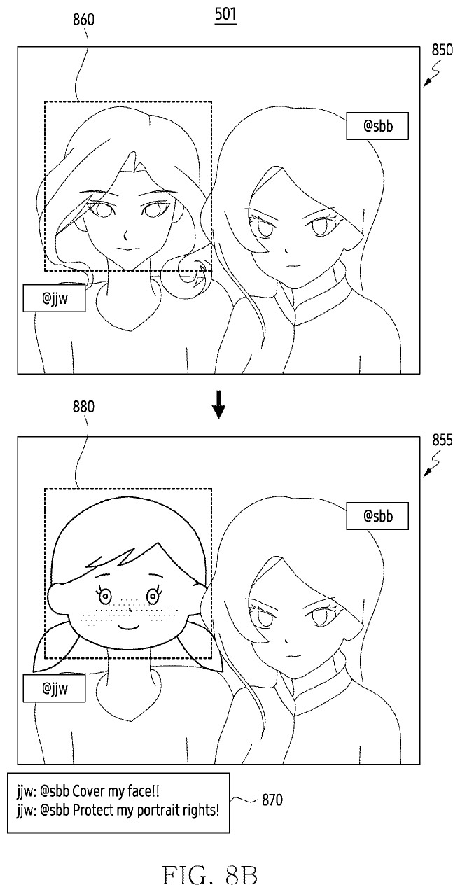

FIG. 8A illustrates an example of a virtual space in which multimedia content is displayed, according to an embodiment. FIG. 8B illustrates an example of a virtual space in which multimedia content is displayed, according to an embodiment. An electronic device 501 of FIGS. 8A and 8B may include the electronic device 501 of FIGS. 5A, 5B, 6, 7A, and/or 7B. Operations of FIGS. 8A and 8B may be executed by the processor 510 of FIGS. 5A and/or 5B. According to an embodiment, FIGS. 8A and 8B are an example in which the electronic device 501 includes a negative reaction in feedback data received from an external electronic device.

Referring to FIG. 8A, according to an embodiment, the electronic device 501 may receive information including first multimedia content 800 from an external electronic device through a communication circuit (e.g., the communication circuit 530 of FIG. 5A and/or FIG. 5B). The electronic device 501 may receive feedback data 820 with respect to the first multimedia content 800 from an external electronic device through a communication circuit. The electronic device 501 may receive information including the first multimedia content 800 and the feedback data 820 with respect to the first multimedia content 800. The electronic device 501 may identify a reaction included in the feedback data 820. For example, the reaction may include a positive reaction and/or a negative reaction. For example, in FIGS. 8A to 8B, the feedback data 820 and 870 may include a negative reaction. For example, the negative reaction may include text such as ‘bad’ and ‘terrible’.

Referring to FIG. 8A, according to an embodiment, the electronic device 501 may identify a portion of the first multimedia content 800. For example, a portion of the first multimedia content 800 may be a portion of a virtual space configured by the first multimedia content 800. For example, a virtual object disposed in a portion of the virtual space may be a portion of the first multimedia content 800. The electronic device 501 may identify a virtual object 810 included in the first multimedia content 800. The electronic device 501 may identify text corresponding to name of the virtual object 810 included in the feedback data 820. For example, the electronic device 501 may identify a reaction associated with the text, based on identifying the text corresponding to name of the virtual object 810. In an example of FIG. 8A, the electronic device 501 may identify ‘dss: It is not good to see a wall frame’. For example, the electronic device 501 may identify the virtual object 810 disposed in the virtual space based on identifying the ‘wall frame’ text. The electronic device 501 may identify that the virtual object 810 and the ‘wall frame’ text match, based on a fact that the virtual object 810 is a frame disposed on a wall in the virtual space. According to an embodiment, the electronic device 501 may identify a reaction with respect to the virtual object 810 based on the matching. For example, the electronic device 501 may identify a negative reaction with respect to the virtual object 810, based on obtaining the ‘dss: It is not good to see a wall frame’ text. The electronic device 501 may remove a portion corresponding to the virtual object 810 based on identifying the negative reaction. The electronic device 501 may cover the virtual object 810 with a color adjacent to the virtual object 810, based on identifying the negative reaction. For example, the electronic device 501 may change a portion displaying the virtual object 810 with the same color as a portion spaced apart by a specified pixel from the virtual object 810. For example, the electronic device 501 may adjust transparency of the virtual object 810. For example, the electronic device 501 may adjust an alpha value associated with the transparency of the virtual object 810. For example, the electronic device 501 may transparently display the virtual object 810 based on adjusting the alpha value of the virtual object 810. For example, the electronic device 501 may cease to display the virtual object 810 based on identifying the negative reaction. The electronic device 501 may obtain the second multimedia content 805 based on a change in a portion displaying the virtual object 810. For example, the electronic device 501 may change a portion 830 on which the virtual object 810 was displayed. The electronic device 501 may obtain the second multimedia content 805 based on changing the portion 830. The electronic device 501 may display the second multimedia content 805 in a display, based on obtaining the second multimedia content 805.

Referring to FIG. 8B, according to an embodiment, the electronic device 501 may receive information including the first multimedia content 850 from an external electronic device through a communication circuit. The electronic device 501 may receive information including the feedback data 870 with respect to the first multimedia content 850 from an external electronic device through a communication circuit. The electronic device 501 may display the first multimedia content 850 and the feedback data 870 in the display, based on receiving the information. For example, the electronic device 501 may display the feedback data 870 in a first area. For example, the electronic device 501 may display the first multimedia content 850 in a second area different from the first area. The second area in which the first multimedia content 850 is displayed and the first area in which the feedback data 870 is displayed may be different from each other.

According to an embodiment, the electronic device 501 may identify a portion of the first multimedia content 850. For example, the electronic device 501 may identify a subject 860 displayed in the first multimedia content 850. For example, the electronic device 501 may identify a tag (e.g., @jjw) of the subject 860. The electronic device 501 may identify a user's identifier (e.g., jjw) included in the feedback data 870. For example, the user's identifier may include an identifier of a user of an external electronic device different from the electronic device 501. The electronic device 501 may identify that the tag and the user's identifier match. For example, the electronic device 501 may identify the user's reaction associated with the subject 860, based on the matching of the tag and the user's identifier. The electronic device 501 may change the subject 860 based on identifying the reaction. For example, the electronic device 501 may identify that the user's reaction includes a negative reaction. The electronic device 501 may change the subject 860 into a virtual object 880 such as an avatar or an image, based on identifying the negative reaction. The electronic device 501 may obtain the second multimedia content 855 based on changing the subject 860 to the virtual object 880. The electronic device 501 may display the second multimedia content 855 in the display, based on obtaining the second multimedia content 855.

According to an embodiment, the electronic device 501 may receive information including the first multimedia content 850 and the feedback data 870 with respect to the first multimedia content 850. The electronic device 501 may obtain the second multimedia content 855 by changing the first multimedia content 850 based on receiving the information. The electronic device 501 may display the second multimedia content 855 in the display, based on obtaining the second multimedia content 855. The electronic device 501 may receive second feedback data from an external electronic device, after obtaining the second multimedia content 855. For example, the second feedback data may include feedback data different from the feedback data 870, which is the first feedback data 870 associated with the second multimedia content 855. For example, the electronic device 501 may change a portion of the second multimedia content 855, based on receiving the second feedback data. An operation of changing a portion of the second multimedia content 855 may be substantially the same as an operation of changing a portion of the first multimedia content 850.

As described above, according to an embodiment, the electronic device 501 may receive the first multimedia content 800 and 850 and the feedback data 820 and 870 with respect to the first multimedia content 800 and 850, from an external electronic device through a communication circuit. The electronic device 501 may change a portion included in the first multimedia content 800 and 850, based on a negative reaction included in the feedback data 820 and 870. For example, the electronic device 501 may change a portion included in the first multimedia content 800 and 850 to the same color as another portion adjacent to the portion, based on the negative reaction. The electronic device 501 may obtain the second multimedia content 805 and 855, based on the first multimedia content 800 and 850 in which the portion is changed. The electronic device 501 may display the second multimedia content 805 and 855 in the display. The electronic device 501 may enhance a user experience of the electronic device 501 by displaying the second multimedia content 805 and 855, based on the feedback data 820 and 870.

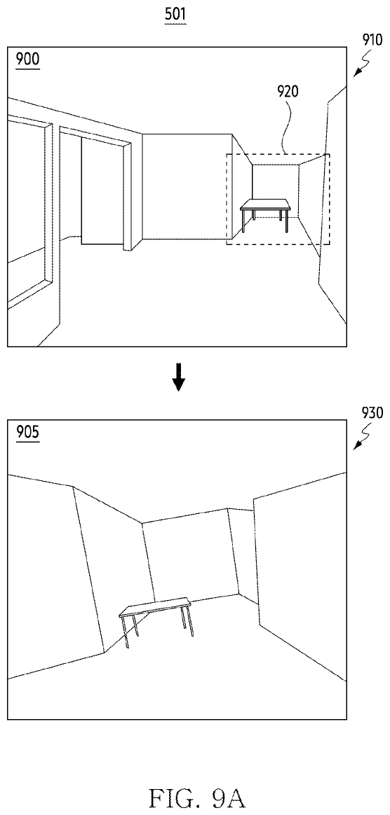

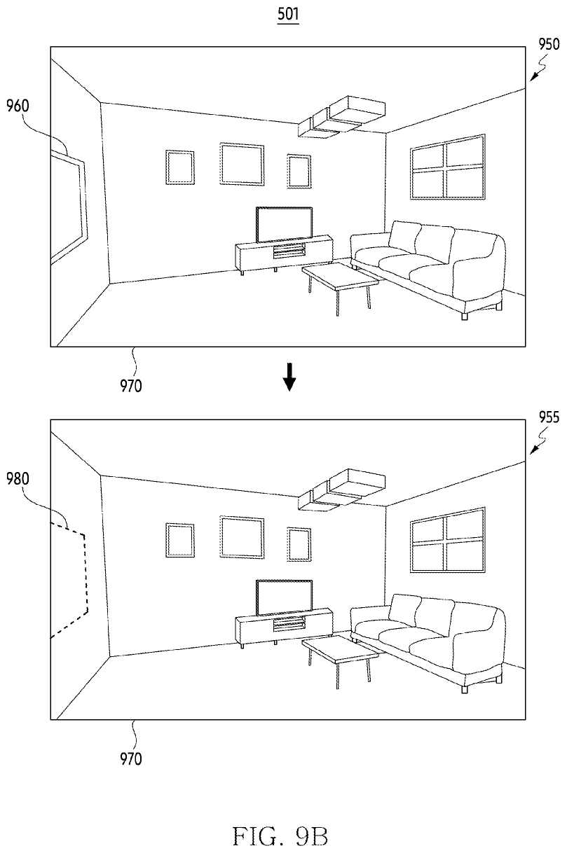

FIG. 9A illustrates an example of a virtual space in which multimedia content is displayed, according to an embodiment. FIG. 9B illustrates an example of a virtual space in which multimedia content is displayed, according to an embodiment. An electronic device 501 of FIGS. 9A and 9B may include the electronic device 501 of FIGS. 5A, 5B, 6, 7A, 7B, 8A, and/or 8B. Operations of FIGS. 9A and 9B may be executed by the processor 510 of FIGS. 5A and/or 5B.

Referring to FIG. 9A, according to an embodiment, the electronic device 501 may display a virtual space 910 associated with a software application in a display (e.g., the display 540 of FIG. 5A and/or FIG. 5B), based on execution of the software application. For example, the virtual space 910 may be referred to as multimedia content. The electronic device 501 may identify feedback data of a user of the electronic device 501 in a first state 900. For example, the electronic device 501 may identify the feedback data associated with the software application in the first state 900. The electronic device 501 may identify the feedback data associated with a virtual space in the first state 900. When the software application is executed or terminated, the feedback data may be generated by an input by a user of the electronic device 501. For example, the feedback data may be generated based on chat log of the user of the electronic device 501 during execution of the software application.

According to an embodiment, when executing a software application, the electronic device 501 may adjust a starting location shown to the user of the electronic device 501, based on the feedback data. For example, the electronic device 501 may obtain the feedback data of the user of the electronic device 501 with respect to a first area 920, which is at least a portion of the virtual space 910. For example, the electronic device 501 may identify a positive reaction of the user of the electronic device 501 with respect to the first area 920, included in the feedback data. The electronic device 501 may store information for displaying the first area 920 within a field-of-view (FoV), based on the user's positive reaction with respect to the first area 920. For example, the first area 920 may be associated with the user's preference and/or interest. For example, the user's preference and/or interest may be obtained based on a time at which a virtual character (or virtual avatar) corresponding to the user is located, during execution of the software application. For example, the user's preference and/or interest may be obtained based on a time at which the first area 920 is displayed in the FoV of the electronic device 501, during execution of the software application. For example, the preference and/or interest with respect to the first area 920 may increase as the time displayed within the FoV increases. For example, the preference and/or interest with respect to the first area 920 may increase as the time at which the virtual character (or virtual avatar) is located in the first area 920 increases. The electronic device 501 may store a parameter associated with the interest and/or preference with respect to the first area 920 in the memory (e.g., the memory 520 of FIG. 5A) of the electronic device 501.

According to an embodiment, the electronic device 501 may identify a parameter associated with the interface and/or preference with respect to the first area 920, stored in the memory. The electronic device 501 may execute a software application for implementing a virtual space. The electronic device 501 may identify a parameter associated with the instance and/or preference, based on execution of the software application. The electronic device 501 may locate a virtual character corresponding to a user of the electronic device 501 in a virtual space implemented by the software application, based on identifying the parameter. For example, the electronic device 501 may display a virtual space 930 in a second state 905 within the virtual space implemented based on the software application. For example, the virtual space 930 in the second state 905 may be a screen displayed when a virtual character corresponding to the user of the electronic device 501 is located in an area (or location) corresponding to the parameter.

Referring to FIG. 9B, according to an embodiment, the electronic device 501 may display a virtual space 970 in the third state 950, based on execution of the software application. The virtual space 970 may be referred to as multimedia content. For example, the electronic device 501 may identify at least one virtual object 960 within a state of displaying the virtual space 970. For example, the virtual object 960 may be referred to as a visual object. The electronic device 501 may obtain user's feedback data with respect to the virtual object 960. The electronic device 501 may obtain the user's feedback data with respect to the virtual object 960, based on the user's chat log and/or a time at which the virtual object 960 is displayed in the user's FoV. The electronic device 501 may designate whether to display the virtual object 960, based on the feedback data. For example, the electronic device 501 may identify the user's negative reaction associated with the virtual object 960 in the feedback data. The electronic device 501 may cease to display the virtual object 960, based on identifying the negative reaction. The electronic device 501 may display the virtual object 960 in the same color as the color of a point spaced apart by a specified pixel from the virtual object 960, based on identifying the negative reaction. For example, the electronic device 501 may display a virtual object with substantially the same color as the color of the point spaced apart by the specified pixel from the virtual object 960, by overlapping with the virtual object 960. According to an embodiment, the electronic device 501 may adjust transparency of the virtual object 960. For example, the electronic device 501 may adjust an alpha value associated with the transparency of the virtual object 960. For example, the electronic device 501 may transparently display the virtual object 960 based on adjusting the alpha value of the virtual object 960.

According to an embodiment, the electronic device 501 may display a virtual space 970 in a fourth state 955. When displaying the virtual space 970 in the fourth state 955, the electronic device 501 may display the virtual space 970 based on the feedback data of the user of the electronic device 501. For example, the electronic device 501 may cease to display the virtual object 960 in the fourth state 955, based on the feedback data with respect to the virtual object 960 identified in the third state 955. For example, the electronic device 501 may display a second area 980 corresponding to the virtual object 960 in the same color as the color of the point spaced apart by a specified pixel from the second area 980. For example, the electronic device 501 may cease to display the virtual object 960. For example, the electronic device 501 may display the virtual space 970, based on ceasing a display of the virtual object 960.

As described above, according to an embodiment, when displaying virtual spaces 910, 930, and 970, the electronic device 501 may display the virtual spaces 910, 930, and 970 based on feedback data with respect to the virtual spaces 910, 930, and 970. The electronic device 501 may change a portion of the virtual spaces 910 and 970 based on the feedback data. The electronic device 501 may display virtual spaces 930 and 970 in different states, based on changing a portion of the virtual spaces 910 and 970. The electronic device 501 may enhance a user experience of the electronic device 501 by displaying the virtual spaces 930 and 970 based on the feedback data.

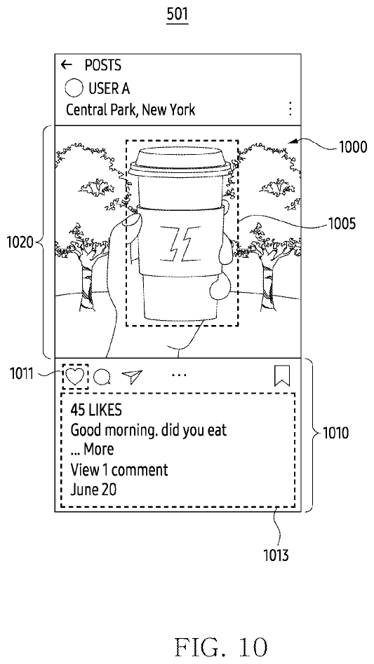

FIG. 10 illustrates an example of a virtual space in which multimedia content is displayed, according to an embodiment. An electronic device 501 of FIG. 10 may include the electronic device 501 of FIGS. 5A, 5B, 6, 7A, 7B, 8A, 8B, 9A, and/or 9B. Operations of FIG. 10 may be executed by the processor 510 of FIGS. 5A and/or 5B.

Referring to FIG. 10, according to an embodiment, the electronic device 501 may display first multimedia content 1000 in a display (e.g., the display 540 of FIG. 5A and/or FIG. 5B). The electronic device 501 may display a visual object associated with feedback data with respect to the first multimedia content 1000. For example, the electronic device 501 may display a visual object associated with the first multimedia content 1000 and the feedback data with respect to the first multimedia content 1000 through a communication circuit (e.g., the communication circuit 530 of FIG. 5A and/or FIG. 5B), based on receiving information including the first multimedia content 1000 and the feedback data with respect to the first multimedia content 1000 transmitted from an external electronic device. The electronic device 501 may display a visual object associated with the feedback data with respect to the first multimedia content 1000 in a first area 1010. For example, the electronic device 501 may display visual objects 1011 and 1013 associated with the feedback data, adjacent to the first multimedia content 1000. For example, the electronic device 501 may display the visual objects 1011 and 1013, adjacent to a portion of the first multimedia content 1000. For example, the feedback data with respect to the first multimedia content 1000 may include a positive reaction and/or a negative reaction with respect to the first multimedia content 1000. For example, the electronic device 501 may display the first multimedia content 1000 based on a 2-dimensional virtual coordinate system.

In an example of FIG. 10, the electronic device 501 may display a visual object 1011 for representing the feedback data with respect to the first multimedia content 1000. The electronic device 501 may display a visual object 1013 for representing the feedback data with respect to the first multimedia content 1000. The electronic device 501 may change the first multimedia content 1000 based on the visual objects 1011 and 1013. For example, the electronic device 501 may identify a reaction of a user of the electronic device 501 and/or a reaction of a user the external electronic device, included in the visual object 1011 and 1013. The electronic device 501 may identify a reaction with respect to the first multimedia content 1000 based on text included in the visual object 1013. For example, the reaction may include a positive reaction and/or a negative reaction.

According to an embodiment, the electronic device 501 may identify the visual object 1005 included in the first multimedia content 1000. The electronic device 501 may identify the feedback data with respect to the visual object 1005. For example, the feedback data may be represented as a visual object 1011. For example, the feedback data may be represented based on text, such as the visual object 1013. The electronic device 501 may change the visual object 1005 based on the feedback data. The electronic device 501 may emphasize the visual object 1005, based on the positive reaction included in the feedback data. For example, the electronic device 501 may expand size of the visual object 1005. For example, the electronic device 501 may highlight the visual object 1005. The electronic device 501 may obtain second multimedia content based on changing the visual object 1005. The electronic device 501 may display the second multimedia content obtained by changing the first multimedia content 1000 in a second area 1020, based on changing the visual object 1005, which is a portion of the first multimedia content 1000.

As described above, according to an embodiment, the electronic device 501 may change at least a portion of the first multimedia content 1000. The electronic device 501 may change the visual object 1005, which is at least a portion of the first multimedia content 1000, based on the feedback data. The electronic device 501 may obtain the second multimedia content based on changing at least a portion of the first multimedia content 1000. The electronic device 501 may display visual objects 1011 and 1013 associated with the feedback data in the first area 1010, based on obtaining the second multimedia content. The electronic device 501 may display the second multimedia content in the second area 1020. The electronic device 501 may enhance a user experience of the electronic device 501, by displaying the second multimedia content obtained by changing at least a portion of the first multimedia content 1000.

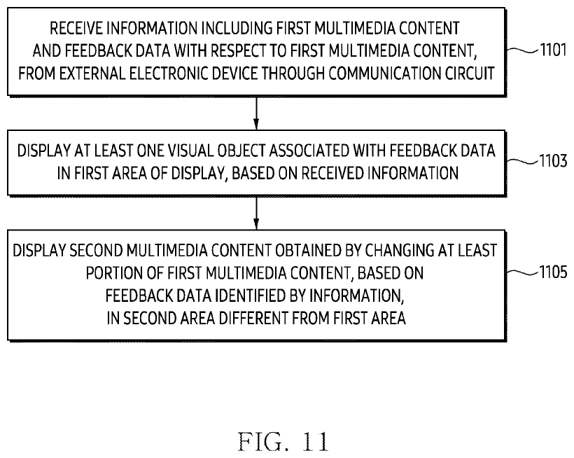

FIG. 11 illustrates an example of a flowchart of an operation of an electronic device, according to an embodiment. An electronic device of FIG. 11 may include the electronic device 501 of FIGS. 5A, 5B, 6, 7A, 7B, 8A, 8B, 9A, 9B, and/or 10. Operations of FIG. 11 may be executed by the processor 510 of FIG. 5A and/or 5B. In the following embodiment, each operation may be performed sequentially, but is not necessarily performed sequentially. For example, the sequence of each operation may be changed, and at least two operations may be performed in parallel.

Referring to FIG. 11, according to an embodiment, in operation 1101, the electronic device may receive information from an external electronic device (e.g., the external electronic device 503 of FIG. 5B or a server) through a communication circuit (e.g., the communication circuit 530 of FIG. 5A and/or FIG. 5B). For example, the electronic device may receive information including first multimedia content and feedback data with respect to the first multimedia content, from the external electronic device through the communication circuit. The electronic device may identify a reaction associated with a user of a second external electronic device different from the external electronic device, which is a first external electronic device, included in the feedback data.

According to an embodiment, in operation 1103, the electronic device may display at least one visual object associated with the feedback data in a first area of a display (e.g., the display 540 of FIG. 5A and/or FIG. 5B), based on information received from the first external electronic device. For example, the visual object may include text and/or a virtual object associated with the user's reaction of the second external electronic device.

According to an embodiment, in operation 1105, the electronic device may display second multimedia content in a second area different from the first area. For example, the electronic device may change at least a portion of the first multimedia content, based on the feedback data included in information transmitted from the external electronic device. For example, the electronic device may identify a positive reaction and/or a negative reaction of the user of the second external electronic device, included in the feedback data included in the information. The electronic device may change at least a portion of the first multimedia content, based on identifying the positive reaction and/or the negative reaction. For example, at least a portion of the first multimedia content may include at least one virtual object included in the first multimedia content. The electronic device may change the at least one virtual object, based on the feedback data. The electronic device may obtain the second multimedia content based on changing at least a portion of the first multimedia content. The electronic device may display the second multimedia content in the second area, based on obtaining the second multimedia content. The electronic device may display the second multimedia content obtained by changing at least a portion of the first multimedia content, in the second area different from the first area, based on the feedback data identified by the information.

As described above, according to an embodiment, the electronic device may change at least a portion of the first multimedia content. The electronic device may change at least a portion of the first multimedia content, based on the feedback data associated with the first multimedia content transmitted from the external electronic device. The electronic device may obtain the second multimedia content based on changing at least a portion of the first multimedia content. The electronic device may display the second multimedia content obtained by changing at least a portion of the first multimedia content. The electronic device may enhance a user experience of the electronic device, by displaying the second multimedia content in which at least a portion of the first multimedia content is changed.

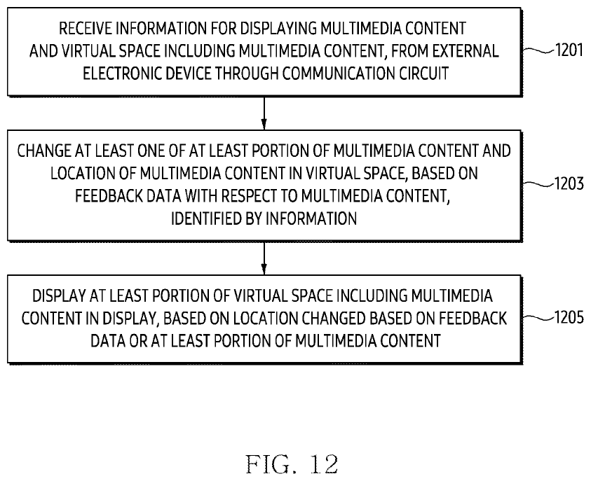

FIG. 12 illustrates an example of a flowchart of an operation of an electronic device, according to an embodiment. An electronic device of FIG. 12 may include the electronic device 501 of FIGS. 5A, 5B, 6, 7A, 7B, 7B, 8A, 8B, 9A, 9B, and/or 10, and/or the electronic device of FIG. 11. Operations of FIG. 12 may be executed by the processor 510 of FIG. 5A and/or FIG. 5B. In the following embodiment, each operation may be performed sequentially, but is not necessarily performed sequentially. For example, the sequence of each operation may be changed, and at least two operations may be performed in parallel.

Referring to FIG. 12, according to an embodiment, in operation 1201, the electronic device may receive information from an external electronic device (e.g., the external electronic device 503 of FIG. 5B or a server) through a communication circuit (e.g., the communication circuit 530 of FIG. 5A and/or FIG. 5B). The electronic device may receive information for displaying multimedia content and a virtual space including the multimedia content, from the external electronic device through the communication circuit. The virtual space may be displayed based on a 2-dimensional virtual coordinate system and/or a 3-dimensional virtual coordinate system.

According to an embodiment, in operation 1203, the electronic device may identify feedback data associated with the multimedia content, based on receiving information from the external electronic device through the communication circuit. The feedback data may include a reaction of a user of the electronic device and/or a reaction of a user of a second external electronic device different from the external electronic device, which is a first external electronic device. For example, information including the multimedia content may include the feedback data associated with the multimedia content. The electronic device may identify the feedback data with respect to the multimedia content, based on the information. The electronic device may change at least a portion of the multimedia content. The electronic device may change a location of the multimedia content in the virtual space. The electronic device may change at least a portion of the multimedia content or at least one of locations of the multimedia content in the virtual space. The electronic device may change at least a portion of the multimedia content or the location of the multimedia content in the virtual space, based on the feedback data with respect to the multimedia content, identified by the information.

According to an embodiment, in operation 1205, the electronic device may display at least a portion of the virtual space including the changed multimedia content in a display (e.g., the display 540 of FIG. 5A and/or FIG. 5B), based on the feedback data. The electronic device may display a location changed based on the feedback data in the virtual space. The electronic device may display at least a portion of the multimedia content changed based on the feedback data, in the virtual space. The electronic device may display at least a portion of the virtual space including the multimedia content, based on the location changed based on the feedback data or at least a portion of the changed multimedia content.

As described above, according to an embodiment, the electronic device may change multimedia content transmitted from the first external electronic device based on feedback data. Based on the feedback data, the electronic device may change a location of the multimedia content included in the information transmitted from the first external electronic device or at least a portion of the multimedia content. The electronic device may display the changed multimedia content in a virtual space. The electronic device may enhance a user experience of the electronic device by displaying the changed multimedia content in the virtual space.

A method for changing multimedia content based on user's feedback may be required.

As described above, according to an embodiment, an electronic device may comprise a communication circuit, a display, and a processor. The processor may be configured to receive, from an external electronic device via the communication circuit, information including first multimedia content and feedback data with respect to the first multimedia content. The processor may be configured to control the display to display, in a first area of the display based on the received information, at least one visual object associated with the feedback data. The processor may be configured to control the display to display, in a second area different from the first area, second multimedia content obtained by changing at least portion of the first multimedia content, based on the feedback data identified by the information.

The electronic device 501 may enhance a user experience by changing multimedia content based on the feedback data.

According to an embodiment, the processor may be configured to receive second feedback data after receiving first feedback data which is the feedback data. The processor may be configured to change, based on receiving the second feedback data, at least portion of the second multimedia content displayed in the display.

According to an embodiment, the processor may be configured to control the display to display the second multimedia content based on 3-dimensional virtual coordinate system.

According to an embodiment, the processor may be configured to control the display to display, based on adjustment of sizes of the first multimedia content, the second multimedia content in the 3-dimensional virtual coordinate system.

According to an embodiment, the processor may be configured to control the display to display, based on changing of coordinates where the first multimedia content are displayed, the second multimedia content in the 3-dimensional virtual coordinate system.

According to an embodiment, the processor may be configured to identify a second visual object different from a first visual object which is the visual object, and included in the first multimedia content. The processor may be configured to display, based on the second visual object and the feedback data, the second multimedia content by changing at least portion of the first multimedia content.

According to an embodiment, the processor may be configured to control the display to display the second multimedia content highlighted based on the second visual object and the feedback data.

According to an embodiment, the processor may be configured to control the display to display at least portion of text included in the feedback data adjacent to the second multimedia content.

According to an embodiment, the processor may be configured to control the display to display the second multimedia content in 2-dimensional virtual coordinate system.

According to an embodiment, a method of an electronic device may comprise receiving, from an external electronic device via the communication circuit, information including first multimedia content and feedback data with respect to the first multimedia content. The method of the electronic device may comprise displaying, in a first area of the display based on the received information, at least one visual object associated with the feedback data. The method of the electronic device may comprise, based on the feedback data identified by the information, displaying, in a second area different from the first area, second multimedia content obtained by changing at least portion of the first multimedia content.

According to an embodiment, the method of the electronic device may comprise receiving second feedback data after receiving first feedback data which is the feedback data. The method of the electronic device may comprise changing, based on receiving the second feedback data, at least portion of the second multimedia content displayed in the display.

According to an embodiment, the method of the electronic device may comprise displaying the second multimedia content based on 3-dimensional virtual coordinate system.

According to an embodiment, the method of the electronic device may comprise displaying, based on adjustment of sizes of the first multimedia content, the second multimedia content in the 3-dimensional virtual coordinate system.

According to an embodiment, the method of the electronic device may comprise displaying, based on changing of coordinates where the first multimedia content are displayed, the second multimedia content in the 3-dimensional virtual coordinate system.

According to an embodiment, the method of the electronic device may comprise identifying second visual object different from first visual object which is the visual object, and included in the first multimedia content. The method of the electronic device may comprise displaying, based on the second visual object and the feedback data, the second multimedia content by changing at least portion of the first multimedia content.

According to an embodiment, the method of the electronic device may comprise displaying the second multimedia content highlighted based on the second visual object and the feedback data.

According to an embodiment, the method of the electronic device may comprise displaying at least portion of text included in the feedback data adjacent to the second multimedia content.

According to an embodiment, the method of the electronic device may comprise displaying the second multimedia content in a 2-dimensional virtual coordinate system.

According to an embodiment, a non-transitory computer readable storage medium storing one or more programs, the one or more programs may comprise instructions which, when executed by a processor of an electronic device, cause the electronic device to receive, from an external electronic device via a communication circuit, information including first multimedia content and feedback data with respect to the first multimedia content. The one or more programs may comprise instructions which, when executed by the processor of the electronic device, cause the electronic device to display, in a first area of a display based on the received information, at least one visual object associated with the feedback data. The one or more programs may comprise instructions which, when executed by the processor of the electronic device, cause the electronic device to display, in a second area different from the first area, second multimedia content obtained by changing at least portion of the first multimedia content, based on the feedback data identified by the information.

According to an embodiment, the one or more programs may comprise instructions which, when executed by the processor of the electronic device, cause the electronic device to receive second feedback data after receiving first feedback data which is the feedback data. The one or more programs may comprise instructions which, when executed by the processor of the electronic device, cause the electronic device to change, based on receiving the second feedback data, at least portion of the second multimedia content displayed in the display.

According to an embodiment, the one or more programs may comprise instructions which, when executed by the processor of the electronic device, cause the electronic device to display the second multimedia content based on a 3-dimensional virtual coordinate system.

According to an embodiment, the one or more programs may comprise instructions which, when executed by the processor of the electronic device, cause the electronic device to display, based on adjustment of sizes of the first multimedia content, the second multimedia content in the 3-dimensional virtual coordinate system.

According to an embodiment, the one or more programs may comprise instructions which, when executed by the processor of the electronic device, cause the electronic device to display, based on changing of coordinates where the first multimedia content are displayed, the second multimedia content in the 3-dimensional virtual coordinate system.

According to an embodiment, the one or more programs may comprise instructions which, when executed by the processor of the electronic device, cause the electronic device to identify a second visual object different from a first visual object which is the visual object, and included in the first multimedia content. The one or more programs may comprise instructions which, when executed by the processor of the electronic device, cause the electronic device to display, based on the second visual object and the feedback data, the second multimedia content by changing at least portion of the first multimedia content.

According to an embodiment, the one or more programs may comprise instructions which, when executed by the processor of the electronic device, cause the electronic device to display the second multimedia content highlighted based on the second visual object and the feedback data.

According to an embodiment, the one or more programs may comprise instructions which, when executed by the processor of the electronic device, cause the electronic device to display at least portion of text included in the feedback data adjacent to the second multimedia content.

According to an embodiment, the one or more programs may comprise instructions which, when executed by the processor of the electronic device, cause the electronic device to display the second multimedia content in a 2-dimensional virtual coordinate system.

According to an embodiment, an electronic device may comprise: a communication circuit, a display, and a processor. The processor may be configured to receive, from an external electronic device via the communication circuit, multimedia content and information for displaying a virtual space including the multimedia content. The processor may be configured to change, based on feedback data with respect to the multimedia content identified by the information, at least one of at least portion of the multimedia content or a location of the multimedia content in the virtual space. The processor may be configured to control the display to display, based on at least portion of the multimedia content or the changed location based on the feedback data, at least portion of the virtual space including the multimedia content in the display.

According to an embodiment, the processor may be configured to identify a visual object which is a portion of the multimedia content. The processor may be configured to change, based on the visual object and the feedback data with respect to the visual object, the visual object.

According to an embodiment, the processor may be configured to change the visual object based on adjusting the size of the visual object.

According to an embodiment, the processor may be configured to display the multimedia content in the 3-dimensional virtual coordinate system.

According to an embodiment, the processor may be configured to display the multimedia content, based on changing a coordinate in which a portion of the multimedia content is displayed, in the 3-dimensional virtual coordinate system.

According to an embodiment, the processor may be configured to control the display to display at least a portion of text included in the feedback data in the display.

According to an embodiment, the processor may be configured to control the display to display at least a portion of the text adjacent to at least a portion of the multimedia content.

According to an embodiment, a method of an electronic device may comprise receiving, from an external electronic device via the communication circuit, multimedia content and information for displaying a virtual space including the multimedia content. The method of the electronic device may comprise changing, based on feedback data with respect to the multimedia content identified by the information, at least one of at least portion of the multimedia content or a location of the multimedia content in the virtual space. The method of the electronic device may comprise displaying, based on at least portion of the multimedia content or the changed location based on the feedback data, at least portion of the virtual space including the multimedia content in the display.

According to an embodiment, the method of the electronic device may comprise identifying a visual object which is a portion of the multimedia content. The method of the electronic device may comprise changing, based on the visual object and the feedback data with respect to the visual object, the visual object.

According to an embodiment, the method of the electronic device may comprise changing the visual object based on adjusting the size of the visual object.

According to an embodiment, the method of the electronic device may comprise displaying the multimedia content in the 3-dimensional virtual coordinate system.

According to an embodiment, the method of the electronic device may comprise displaying the multimedia content, based on changing a coordinate in which a portion of the multimedia content is displayed, in the 3-dimensional virtual coordinate system.

According to an embodiment, the method of the electronic device may comprise displaying at least a portion of text included in the feedback data in the display.

According to an embodiment, the method of the electronic device may comprise displaying at least a portion of the text adjacent to at least a portion of the multimedia content.

According to an embodiment, a non-transitory computer readable storage medium storing one or more programs, the one or more programs may comprise instructions which, when executed by a processor of an electronic device, cause the electronic device to receive, from an external electronic device via the communication circuit, multimedia content and information for displaying a virtual space including the multimedia content. The one or more programs may comprise instructions which, when executed by the processor of the electronic device, cause the electronic device to change, based on feedback data with respect to the multimedia content identified by the information, at least one of at least portion of the multimedia content or a location of the multimedia content in the virtual space. The one or more programs may comprise instructions which, when executed by the processor of the electronic device, cause the electronic device to display, based on at least portion of the multimedia content or the changed location based on the feedback data, at least portion of the virtual space including the multimedia content in the display.

According to an embodiment, the one or more programs may comprise instructions which, when executed by the processor of the electronic device, cause the electronic device to identify a visual object which is a portion of the multimedia content. The one or more programs may comprise instructions which, when executed by the processor of the electronic device, cause the electronic device to change, based on the visual object and the feedback data with respect to the visual object, the visual object.

According to an embodiment, the one or more programs may comprise instructions which, when executed by the processor of the electronic device, cause the electronic device to change the visual object based on adjusting the size of the visual object.

According to an embodiment, the one or more programs may comprise instructions which, when executed by the processor of the electronic device, cause the electronic device to display the multimedia content in the 3-dimensional virtual coordinate system.

According to an embodiment, the one or more programs may comprise instructions which, when executed by the processor of the electronic device, cause the electronic device to display the multimedia content, based on changing a coordinate in which a portion of the multimedia content is displayed, in the 3-dimensional virtual coordinate system.

According to an embodiment, the one or more programs may comprise instructions which, when executed by the processor of the electronic device, cause the electronic device to display at least a portion of text included in the feedback data in the display.

According to an embodiment, the one or more programs may comprise instructions which, when executed by the processor of the electronic device, cause the electronic device to display at least a portion of the text adjacent to at least a portion of the multimedia content.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication circuit;
a display; and
a processor, wherein the processor is configured to:
receive, from an external electronic device via the communication circuit, information including first multimedia content and feedback data with respect to the first multimedia content;
control the display to display, in a first area of the display based on the received information, at least one visual object associated with the feedback data; and
based on the feedback data identified by the information, control the display to display, in a second area different from the first area, second multimedia content obtained by changing at least portion of the first multimedia content.

2. The electronic device of claim 1, wherein the processor is configured to:
receive second feedback data after receiving first feedback data which is the feedback data; and
change, based on receiving the second feedback data, at least portion of the second multimedia content displayed in the display.

3. The electronic device of claim 1, wherein the processor is configured to:
control the display to display the second multimedia content based on a 3-dimensional virtual coordinate system.

4. The electronic device of claim 3, wherein the processor is configured to:
control the display to display, based on adjusting sizes of the first multimedia content, the second multimedia content in the 3-dimensional virtual coordinate system.

5. The electronic device of claim 3, wherein the processor is configured to:
control the display to display, based on changing of coordinates where the first multimedia content is displayed, the second multimedia content in the 3-dimensional virtual coordinate system.

6. The electronic device of claim 1, wherein the processor is configured to:
identify a second visual object different from a first visual object which is the visual object, wherein the second visual object is included in the first multimedia content; and
control the display to display, based on the second visual object and the feedback data, the second multimedia content by changing at least portion of the first multimedia content.

7. The electronic device of claim 6, wherein the processor is configured to:
control the display to display the second multimedia content highlighted based on the second visual object and the feedback data.

8. The electronic device of claim 1, wherein the processor is configured to:
control the display to display at least portion of text included in the feedback data adjacent to the second multimedia content.

9. The electronic device of claim 1, wherein the processor is configured to:
control the display to display the second multimedia content in a 2-dimensional virtual coordinate system.

10. A method of an electronic device, comprising:
receiving, from an external electronic device via a communication circuit, information including first multimedia content and feedback data with respect to first multimedia content;
displaying, in a first area of a display based on the received information, at least one visual object associated with the feedback data; and
based on the feedback data identified by the information, displaying, in a second area different from the first area, second multimedia content obtained by changing at least portion of the first multimedia content.

11. The method of claim 10, further comprising:
receiving second feedback data after receiving first feedback data which is the feedback data; and
changing, based on receiving the second feedback data, at least portion of the second multimedia content displayed in the display.

12. The method of claim 10, further comprising:
displaying the second multimedia content based on a 3-dimensional virtual coordinate system.

13. The method of claim 12, further comprising:
displaying, based on adjusting sizes of the first multimedia content, the second multimedia content in the 3-dimensional virtual coordinate system.

14. The method of claim 12, further comprising:
displaying, based on changing of coordinates where the first multimedia content is displayed, the second multimedia content in the 3-dimensional virtual coordinate system.

15. The method of claim 10, further comprising:
identifying a second visual object different from a first visual object which is the visual object, wherein the second visual object is included in the first multimedia content; and
displaying, based on the second visual object and the feedback data, the second multimedia content by changing at least portion of the first multimedia content.

16. The method of claim 15, further comprising:
displaying the second multimedia content highlighted based on the second visual object and the feedback data.

17. The method of claim 10, further comprising:
displaying at least portion of text included in the feedback data adjacent to the second multimedia content.

18. The method of claim 10, further comprising:
displaying the second multimedia content in a 2-dimensional virtual coordinate system.

19. An electronic device, comprising:
a communication circuit;
a display; and
a processor, wherein the processor is configured to:
receive, from an external electronic device via the communication circuit, multimedia content and information for displaying a virtual space including the multimedia content;
change, based on feedback data with respect to the multimedia content identified by the information, at least one of at least portion of the multimedia content or a location of the multimedia content in the virtual space; and
control the display to display, based on at least portion of the multimedia content or the changed location based on the feedback data, at least portion of the virtual space including the multimedia content in the display.

20. The electronic device of claim 19, wherein the processor is configured to:
identify a visual object which is a portion of the multimedia content; and
change, based on the visual object and the feedback data with respect to the visual object, the visual object.
